(19) United States
(12) Patent Application Publication
(10) Pub. No.: US 2023/0191310 A1
(43) Pub. Date: Jun. 22, 2023

(54) Trapezoidal-Duct Assisting Poulty Ammonia Gas, Hydrogen Sulfide Gas, and Dust Removal System

(71) Applicant: Chong Mook Park, Sterling, VA (US)

(72) Inventor: Chong Mook Park, Sterling, VA (US)

(21) Appl. No.: 17/803,921

(22) Filed: Jan. 26, 2023

(51) Int. Cl. B01D 53/04; B01D 53/58; B01D 53/78; B01D 46/00; A01K 1/00

(52) U.S. Cl. CPC B01D 53/0446; B01D 53/58; B01D 53/78; B01D 46/0036; A01K 1/0047; B01D 2251/502; B01D 2257/406; B01D 2257/304; B01D 2258/0266

(57) ABSTRACT

The present invention involves a fabrication of a trapezoidal-duct assisting poultry ammonia gas, hydrogen sulfide gas, and dust removal system to be used for removing of the poultry ammonia gas, hydrogen sulfide gas, and dust from the exhausted air stream emitting from the poultry houses and litter storages, comprising a poultry ammonia gas removal tube-screen-scrubber device invented in the present invention, hydrogen sulfide gas adsorber, dust filter, air-speed-acceleration trapezoidal-duct, ventilation-fan, and auxiliary system. The poultry ammonia gas removal tube-screen-scrubber equipped in the poultry ammonia gas removal tube-screen-scrubber device is invented in the present invention using the tube-screen-fill pack patented by the present inventor for use in the water cooling tower. The air-speed-acceleration controller trapezoidal-duct is applied for connecting of the large air outlet cross section of the tube-screen-scrubber device and the small air inlet cross section of the ventilation fan.

### CROSS REFERENCE TO RELATED APPLICATION

### REFERENCE CITED

### U.S. Patent Documents

U.S. Pat. No. 10,046,502 B2, Aug. 14, 2018, Park

U.S. Pat. No. 8,973,908 B2, Mar. 10, 2015, Park

U.S. application Ser. No. 17/401,195, Aug. 12, 2021, Park

U.S. application Ser. No. 13/888.327, May. 6, 2013, Park

U.S. Pat. No. 6,260,830 B1, Jul. 17, 2001, Harrison

### ARTICLE REFERENCES

1. Journal of Toxicology and Environmental Health, Part A, 76:230-239, 2013, ISSN: 1528-7394 print/1087-2620 online, DOI: 10.1080/15287394.2013.757199⋅Source: PubMed.
2. The Role of Packing Media in a Scrubber Performance Removing Sulfuric Acid Mists, Jafari, et al, International Journal of Occupational Hygiene, IJOH 4: 26-31, 2012, https://eprints.arums.ac.ir/12932/1/54-Article%20Text-67-1-10-20151010.pdf.
3. https://www.machengineering.com/random-packing-vs-structured-packing.
4. Ammonia Emissions from Poultry Industry More Harmful to Chesapeake Bay than Previously Thought, by Environmental Integrity Project, Jan. 22, 2018. Tubes, Crossflow over, Sunden, Bengt, DOI: 10.1615/AtoZ.t.tubes_crossflow_over. https://www.thermopedia.com/content/1216/
5. Beatle, Steven B., Crossflow, Thermopedia, DOI: 10.1615/AtoZ.C.crossflow, https://www.thermopedia.com/content/674/
6. https://www.nuclear-power.com/nuclear-engineering/fluid-dynamics/internal-flow/
7. George P. Kouropoulos, The Effect of The Reynolds Number of Air Flow to The Particle Collection Efficiency of a Fibrous Filter Medium with Cylindrical Section, Journal of Urban and Environmental Engineering, Vol. 8, No. 1 (January to June 2014), pp 3-10 https://www.jstor.org/stable/10.2307/26203405

### BACKGROUND OF THE INVENTION

### 1. Field of the Invention

The present invention relates to a trapezoidal-duct assisting poultry ammonia gas, hydrogen sulfide gas, and dust removal system to be used for removing of the poultry ammonia gas, hydrogen sulfide gas, and dust from the exhausted air stream emitting from the poultry houses and litter storages, comprising a poultry ammonia gas removal tube-screen-scrubber device, hydrogen sulfide gas adsorber, dust filter, air-speed-acceleration trapezoidal-duct, ventilation-fan, and auxiliary system. More precisely, the poultry ammonia gas removal tube-screen-scrubber device equipped in the trapezoidal-duct assisting poultry ammonia gas, hydrogen sulfide gas, and dust removal system is invented in the present invention using the tube-screen-fill pack patented by the present inventor for removing the ammonia gas from the exhausted air stream and the air-speed-acceleration controller trapezoidal-duct is applied for connecting of the large air outlet cross section of the tube-screen-scrubber device and the small air inlet cross section of the ventilation fan.

### 2. Description of the Related Art

As an ammonia (NH₃) highly soluble in water, the NH₃ gas is instantly dissolved into water when the NH₃ gas comes in contact with any water. So, the NH₃ gas in the exhausted air stream discharging from the poultry facilities is easily removed into water stream by bringing the exhausted air stream into direct contact with water stream passing through an NH₃ gas wet-scrubber. Currently, several kinds of the wet-scrubbers to put vapor and liquid into contact each other are operated in the industrial applications. However, the most of them are not appropriate to be used for combining with ventilation fan operating at the poultry facilities, so that the new type wet-scrubber device appropriate to be used for development of a poultry NH₃ gas removal system is invented in the present invention. The related arts for developing the poultry NH₃ gas removal system and the new type wet-scrubber device are described bellow.

<Characteristics and Environmental Effects of Exhausted Air Streams from Poultry Production Facilities> The exhausted air streams emitting through ventilation fans of the poultry production facilities (poultry houses and litter storages) contain NH₃ gas, hydrogen sulfide (H₂S) gas, and dust-particles which are major environmental air pollutants being hazardous to the environments and residential communities surrounding the poultry farms and spreading out into the ambient air and downwind nearby. Especially, the NH₃ and H₂S gases are so strong pungent smell that the residential communities surrounding the poultry farms strongly oppose the expansion of the existing poultry farms. The dust-particles are pathogenic dust-particles carrying various kinds of pathogens so that short-term and long-term exposures to ambient levels of pathogenic dust-particles are associated with respiratory and cardiovascular illness and mortality as well as other ill-health effects [1]. Although those three pollutants are directly hazardous to nearby residential communities surrounding the poultry farms, the airborne NH₃ gas has particularly a crippling impact on the wide range of land and waterways by flying downwind far away from the poultry farms such as the Chesapeake Bay is seriously contaminated with ammonium as reported in “Report finds Easton Shore chicken farming a main cause of Chesapeake Bay pollution” by WBALTV 11 and “Poultry Pollution in the Chesapeake Region” by Environmental Integrity Project, Apr. 22, 2020. Hence, the NH₃ gas should have removed at the origin of spreading the exhausted pollutants emitting from the poultry farms. But still such NH₃ gas removal systems are not currently operated on site of the poultry farms. To prevent such crippling impact on the wide ranged lands and Chesapeake Bay watersheds, the NH₃ gas must be thoroughly removed at the origin of spreading the exhausted pollutants emitting from the poultry farms. To achieve the thorough removal of the NH₃ gas, the tube-screen-scrubber device having a high removal efficiency of NH₃ gas is invented in the present invention and a trapezoidal-duct assisting poultry NH₃ gas, H₂S gas, and dust-particles removal system applicable to the poultry facilities such as poultry houses and litter storages is uniquely developed using the tube-screen-scrubber device invented in the present invention.

<Characteristics of Ammonia Gas in Water> The gas phase ammonia (NH₃(g)) has high solubility in water, so that the NH₃(g) easily dissolves in the water to become liquid phase (aqueous) ammonia (NH₃(aq)) in water as follows.

NH₃(g)+H₂O ↔ NH₃(aq)+H₂O (1)

If the aqueous ammonia NH₃(aq) in the water is not changed in other chemical form, the NH₃(aq) is ready to convert back to NH₃(g) to volatilize into the ambient air. To prevent the converting back to NH₃(g) of the NH₃(aq), the water is made acid by adding hydrocloride solution (HCl) or other form of acid to the water. Then, the NH₃(aq) is captured by acid (H⁺) to become liquid phase ammonium ions, NH₄⁺(aq), by chemical reaction with HCl as follows.

NH₃(aq)+H⁺+Cl⁻+H₂O ↔ NH₄Cl+H₂O ↔ NH₄⁺(aq)+Cl⁻(aq)+H₂O (2)

The ammonium chloride, NH₄Cl, produced by chemical reaction between the NH₃(aq) and HCl is a salt of strong acid which is highly soluble in water to produce cationic ions NH₄⁺ and anionic ions Cl⁻, so that it decomposes into its component ammonium cations, NH₄⁺(aq) and chloride anion Cl⁻(aq) as shown in Eq (2). The second equilibrium reaction occurs owing to capturing of the NH₃(aq) in the first equilibrium state by the acid H⁺ in the acid water to form liquid phase ammonium ions NH₄⁺(aq). As a result of NH₃(aq) converting to NH₄⁺(aq) in the second equilibrium reaction to fill the vacancies of the NH₄⁺(aq) in the acid water, the vacancy of the NH₃(aq) in the second equilibrium state is replaced with NH₃(g) in the first equilibrium state and consecutively the vacancy of the NH₃(g) in the first state is filled with ammonia gas in the ambient air contacting on the surface of the acid water by dissolving process of NH₃(g) into the acid water. Thus, while the vacancies of the NH₄⁺ ions are enough in the acid water, the NH₃(aq) present in the ammonia-dissolved acid water does not volatilize back into the ambient air because the NH₃(aq) is rapidly converted into NH₄⁺(aq) owing to being captured by acid H⁺ present in the acid water, which explains why the scrubbing water stream in the scrubber is necessary to be kept in acid state for continuously absorbing ammonia gas from the air stream. When the above two reaction equilibriums come into play in the ammonia-dissolved-water (ammonium chloride water), they are maintained until the equilibrium state is broken. Namely, the six chemical components such as NH₃(g), NH₃(aq), H₂O, NH₄⁺(aq), Cl⁻, and H⁺ are present in the ammonia-dissolved-water. In such an equilibrium state of the six chemical components present in the ammonia-dissolved-water which is contacting with an ambient air contaminated with ammonia gas. If the more ammonia gas dissolves in the ammonia-gas-water from the ambient air (ammonia-gas-rich-air), the more ammonium ion, NH₄⁺(aq), is produced in the ammonia-dissolved-water to keep the equilibrium states among the six chemical components as shown in Eqs (1) and (2). On the contrary, if the NH₃(g) present in the ammonia-dissolved-water volatilizes into the ambient air contacting the ammonia-dissolved-water due to the difference of mutual surface pressure between the ammonia-dissolved-water and the ambient air, the NH₄⁺(aq) is converted back to the NH₃(g) to fill the vacancy of the NH₃(g) through the equilibrium converting process of the NH₄⁺(aq) to keep the equilibrium state of the six chemical components to keep the equilibrium state between the six chemical components when the ammonia-dissolved-water is stationary. However, when the ammonia-dissolved-water is moving out of the system contacting of air stream and ammonia-dissolved water by circulating through the circulation pipe, the NH₃ gas in the NH₃ gas contaminated air stream continuously dissolves into the circulating ammonia-dissolved water through the contacting interfaces between the air and acid water streams until the NH₄⁺(aq) is fully filled in the circulated ammonia-dissolved water. Hence, it is understood that the NH₃(g) in the NH₃ gas contaminated air stream is continuously dissolved into the acid water having vacancies of the NH₄⁺ ions produced due to a forced removal of the NH₄⁺ ions out of the system by passing the NH₄⁺ dissolved acid water through an ion exchanger columns.

<Scrubbing Principle of Wet-Scrubber> The wet-scrubber is a module filled with a single big material or multiple materials specially designed to put gas and liquid into contacting each other on the surface of the materials. The material is made of by making a plenty of small or large tunnel holes or voids for gas and liquid to pass throughout the materials and for gas and liquid to contact each other on the surface area to be made as large as possible to maximize a contacting of gas and liquid. Usually liquid is sprayed on the top of the wet-scrubber module and flows down on the surface of the packing materials in the module by gravity force to get the material surfaces wetted and the gas is transversely or vertically upwards passing through the module by force to contact with liquid flowing down on the surfaces of the packing materials.

<Evaluation of Tube-Screen-Scrubber from Testing Results of Tube-Screen-Fill Pack and PVC Film-Fill Pack Using Prototype Water Cooling Tower> The gas and liquid contact module of the wet-scrubber has a same function with that of a cooling tower PVC film-fill pack to be loaded in the cooling tower, since the cooling tower PVC film-fill pack put hot water and cool air into contacting each other (counter current or cross current contacting) on the surface of the PVC film-fill pack in the cooling tower. Hence, the tube-screen-fill pack invented by the present inventor for using in the cooling tower is employed as the ammonia gas removal tube-screen-scrubber pack to be installed in the wet-scrubber device. The tube-screen-fill pack has a 30% higher water cooling efficiency compared to that of the current cooling tower PVC film-fill pack. The tube-screen-fill pack has a specific surface area of 24 ft²/ft³ compared to 55 ft²/ft³ for cooling tower PVC film-fill pack. Such an information on the tube-screen-fill pack invented by the present inventor has been obtained from operation of the prototype cooling tower for the performance testing of the tube-screen-fill pack and counterpart sample cooling tower PVC film-fill pack. Based on such a superior cooling performance of the tube-screen-fill pack compared to the current PVC Film-Fill pack using in cooling towers, the tube-screen-scrubber device invented in the present invention using the tube-screen-fill invented by the present inventor in developing the poultry NH₃ gas removal system is expected to achieve the same superior performance result of removing the NH₃ gas from the exhausted NH₃ gas contaminated air stream emitting from the poultry facilities compared to the current wet scrubbers.

<Evaluation of Tube-Screen-Scrubber by Comparing Structural Configurations of PVC Film-Fill and Tube-Screen-Fill> The plate-shape-film-fill used for fabricating of a film-fill pack employed in current cooling towers comprises obverse and reverse corrugated surfaces of the plate-shape-film-fill. To fabricate a film-fill pack, a plenty of such corrugated film-fill plates are assembled side by side after horizontally rotating every other the corrugated film-fill plates by 180 degree with push-button connectors provided on the plates jointed by pushing them. Then, the two film-fill plates create multiple air-flowing channels formed between them being able to generate spiraling-air flowing of the air-streams flowing between plates. The air spiraling in a channel results in greater mixing rate between the air and fluid, which provides improved mass transfer between the two media, air and working solution, referring to U.S. Pat. No. 6,260,830 B1. However, the PVC film-fill pack has a crucial big drawback such as the air streams flowing through channels between adjacent film-fill plates are resisted by the channel walls and blocked by push-button connectors between the plates which cause the high pressure drop over the PVC film-fill pack. Another big drawback of PVC film-fill pack is that the air streams flowing through the one channel formed between adjacent film-fill plats are not horizontally mixed with the air flowing through other channel between the other adjacent film-fill plates. Such structural drawback of the current film-fill pack does not maximize the contact of air and fluid throughout the entire pack and minimize the pressure drop due to obstructing of the PVC film-fill plates to the flowing of air between the adjacent plates of the PVC film-fill pack. Those drawbacks of the PVC film-fill packs are not occurred within the tube-screen-scrubber which has been approved from the prototype testing results described above in the section of <Evaluation of Tube-Screen-Scrubber from Testing Results of Tube-Screen-Fill Pack and PVC Film-Fill Pack Using Prototype Water Cooling Tower>.

<Current Wet-Scrubbers Operated in Industries> The wet-scrubbers currently being operated in the industrial applications are spray nozzle scrubbers, venturi scrubbers, spray towers, and packed bed scrubbers, which are grouped according to the method of contacting gas and liquid. The spray nozzle and tower scrubbers use a direct contacting method of gas stream and liquid droplets produced by spraying of liquid into the gas stream with high pressure through nozzles, and the venturi scrubber uses a venturi shape contactor to increase contacting surfaces between gas stream and liquid droplets by increasing turbulence atomizing the liquid droplets. The packed bed scrubber consists of a random packing scrubber filled with variously shaped gas and liquid contacting materials such as spiral rings, raschig rings (small pieces of 1 inch tubes), Tri-Packs (spherical or oval shaped contacting materials with lots of holes like bicycle helmets on surfaces) and structured packing scrubber filled with multiple pieces of large structured material like grid packing and laboratory packing or one piece of structured material like honeycomb packing. Judging the contacting methods of gas and liquid within the scrubbers, based on simple descriptions for each of packed bed scrubbers described in the above article, it is easily determined that the structured packing scrubbers are right scrubbers applicable to be combined with the ventilation fans attached on the wall of the poultry houses. The structural configuration of the structure packing scrubber like honeycomb packing has significant drawbacks of gas passing honeycomb shaped channels embedded in the honeycomb packing. The gas passing through the channel holes is obstructed at a plenty of cold-slag-walls on channels in the honeycomb packing until the gas has passed completely through the channels, so that the pressure drop is significant high. Also, the major disadvantage of the random packing scrubber is that pressure drop of the gas flowing over the random packing materials is not significant problem at low speed of gas passing through the packing materials, but at high speed of flowing gas, a high pressure drop definitely occurs since strong obstructing of flowing gas comes into play due to continuous head-on collisions of flowing gas on the random packed various formed materials packed in the scrubber, according to the rule of that the higher speed of flowing gas is, the higher pressure drop occurs.

<Determination of Packed Bed Scrubber> A contact of air and water in the packed bed scrubber occurs on the surface of the packed materials filled in the packed bed scrubber. The water supplies into the packed bed scrubber by spraying on the top of the packed bed in the scrubber and flows down on the surface of the packed bed. The air blows into the scrubber through the side or bottom of the scrubber by force and passes transversely (cross-current type) or vertically (counter-current type) throughout the packed bed, respectively. Hence, the cross-current type packed bed scrubber is appropriated to be combined with the ventilation fan because the forced air stream horizontally passes through the ventilation fan installed at the poultry house. And another reason to employ the cross current type packed bed scrubber in the present invention is that any high speed of an air stream can be adjusted to an allowable speed to pass transversely through the cross-current-type packed bed scrubber by using an air-speed-adjustable trapezoidal-duct between the cross-current-type packed bed scrubber and ventilation fan. The ventilation fan blows out the poultry odors and dust particles from the poultry houses in a high speed of around 1300-1500 ft/min. The cross-current-type packed bed scrubber uses an air speed of around 400-600 ft/min which is a well known air speed allowable in the wet-scrubber. If a higher speeding air blows through such a packed bed scrubber, the water flowing on the surfaces of the packed bed is blown away from the packed bed, so that the ventilation fans blowing a high speed flowing air are not directly applied to the packed bed scrubber and therefore the high speed flowing air should be reduced to 400-600 ft/min. Thus, other scrubbers described above except for the cross current type packed bed scrubber are not suitable to be combined with the ventilation fan because the air speed passing the scrubber cannot be adjusted to around 500 ft/min. A method of adjusting air speed passing through the cross current type packed bed scrubber is described in the section of <Adjustment of Standard Poultry AHD Removal Equipment into Expanded Poultry AHD Removal Equipment>

<Disadvantages of Current Cross-Current-Type Packed Bed on the Market> Since the cross-current-type packed beds are usually filled with a plurality of packing materials such as raschig rings, spiral rings, spherical or oval shape plastic balls with lots of holes on the surfaces, etc, to reduce a blocking or obstructing of the air flowing through the packing materials and to increase contacting surface area between air and water streams flowing over the packing materials, the flowing conditions are expected as follows: the air stream passes throughout the cross current type packed bed with low pressure drop or the surface of the cross-current-type packed bed is fully wetted or the air and water uniformly contact each other on the surface of the bed. However, the random packing of such packing materials has various disadvantages such as poor distributed air flow over the surfaces, poor wetting surfaces, and non uniform contacting air and water on the surfaces of the packing materials. Such disadvantages of the current packing materials in the cross-current-type packed bed scrubber described above affect an NH₃ gas removal efficiency of the cross-current-type packed bed scrubber significantly low. Especially, in a case of employing small size packing materials to maximize the contacting surface area, the drawbacks caused by random packing of small size packing materials provide the high pressure-drop of flowing air passing throughout such small packing materials [2]. So, to make up for such a high pressure drop, generally large packing materials are employed in the scrubber. Then, the larger the sizes of packing materials are, the smaller the available surface area for contacting between air and water streams which leads to the lower contacting efficiency of air with water. For supplementing of such drawbacks of the current wet scrubbers for applying to the ventilation systems of the current operating poultry facilities, the tube-screen-scrubber device is invented, which has capabilities of uniformly distributing water to evenly wet the entire packing materials and of smoothly passing of air streams through the packing bed without blocking and less obstructing of flowing to contact with water flowing down over the surfaces of packing materials vertically installed in the tube-screen-scrubber device. Especially, the tube-screen-scrubber device has an easily-controlled large surface area and low pressure drop compared to the current packed bed scrubbers. The tube-screen-scrubber pack equipped in the tube-screen-scrubber device invented in the present invention meets the well-known requirements of packing materials being necessary to effectively perform scrubbing of gas: not interact chemically with fluid (gas and liquid) and strongly packed but lightweight, containing enough passageways for liquid to flow through without obstructing fluid or causing pressure drop of gas flow, and allowing for a proper amount of contact between liquid and gas [3], which are verified by operating of the prototype cooling tower for the performance testing of the tube-screen-fill pack and current cooling tower PVC film fill pack. The testing results are that the tube-screen-fill pack has a 30% higher water cooling efficiency compared to that of the current cooling tower PVC film fill pack and that the tube-screen-fill pack has a specific surface area of 24 ft²/ft³ compared to 55 ft²/ft³ for cooling tower PVC film fill pack. Such performance testing results of the PVC film fill pack and tube-screen-fill pack are enough to verify the scrubbing performance of the tube-screen-scrubber device, since their structural configurations and contacting methods of air and water are exactly same.

### SUMMARY OF THE INVENTION

To supplement the disadvantages of the current wet-scrubbers for removing the poultry NH₃ gas, H₂S gas, and dust from the exhausted air stream discharging from the poultry production houses and litter storages, the tube-screen-scrubber device shown in FIG. 1 is invented in the present invention using the tube-screen-fill pack patented by the present inventor for using in the cooling tower to replace the PVC film fill pack and employed to uniquely develop a trapezoidal-duct assisting poultry Ammonia (NH₃) gas, Hydrogen Sulfide (H₂S) gas, and Dust (AHD) removal system, comprising the poultry NH₃ gas removal tube-screen-scrubber device, H₂S gas adsorber, dust filter, air-speed-acceleration trapezoidal-duct, tunnel-ventilation-fan, and auxiliary system as shown in FIG. 15. The poultry NH₃ gas removal tube-screen-scrubber device equipped in the trapezoidal-duct assisting poultry AHD removal system comprises a tube-screen-scrubber pack, a water supply box, and water collection sump which are on top and bottom of the tube-screen-scrubber pack, respectively, as shown in FIG. 1. The tube-screen-scrubber pack consists a plurality of tubes or strings or rods (e.g. after this, tubes or strings or rods are replaced by tube or tubes, tube-screen-scrubber pack is fabricated with tubes, rods, or strings) vertically suspended between top and bottom perforated plates of the tube-screen-scrubber pack in a shape of square box as shown in FIG. 2, which has the several advantages for removing the NH₃ gas from the NH₃-gas-contaminated air streams as follows.
1. The tube-screen-scrubber pack barely creates scales and fouling on the surface area of the scrubber.
2. The tube-screen-scrubber pack has a high dissolving efficiency of NH₃ gas into acid water.
3. The tube-screen-scrubber pack uses the entire surfaces of the tubes, thereby maximizing removing rate of NH₃ gas in a relatively small volume.
4. The tube-screen-scrubber pack can be of rugged construction with ability to withstand without their damage or loss of shape.
5. The tube-screen-scrubber packed material is non-toxic, non-hazardous, and suitable for easy and safe disposal at the end of service life.

The tube-screen-scrubber pack has a high dissolving efficiency of NH₃ gas in water, compared with the dissolving efficiencies of the other scrubbers. The advantages of the tube-screen-scrubber pack to achieve the high dissolving efficiency of the NH₃ gas in water are described bellow.
1. The scrubbing of NH₃ gas works entirely and uniformly on the whole surface area of the scrubbing materials (tubes) as water flows down freely on the whole smooth surfaces of tubes which do not have any protruding parts on the surfaces of tubes to disturb or obstruct flowing down of water.
2. The forced input air transversely passes over and contacts on the entire surface of the acid water flowing down on the whole surface area of the scrubbing materials of tubes because the tubes vertically suspended in the scrubber are straightly lined up in parallel and in the transverse direction to the flowing of air and because they are arranged in zigzag-shapes along the flowing of air. As the tubes are vertically positioned in the zigzag-shapes along the direction of the flowing air, the entire flowing air can directly come in contact with all of tubes and flows smoothly over the round surfaces of the water flowing down on the tube surfaces. Such interactions of the flowing air over the water flowing down on the tube surfaces continuously occur while the air is transversely passing through the tubes in the scrubber until the air is completely discharged out of the scrubber device without significantly reducing of the speed of flowing air. The interactions of the flowing air with the water film flowing down over the surfaces of all tubes occur a plenty of times while passing transversely through the tube-scrubber packing bed, so that the NH₃ gas contaminated in the exhausted air stream is completely dissolved into the water due to transporting of the NH₃ gas contaminated in the exhaust air stream through the contacting interfaces of the air and water streams into the flowing water stream by dissolving mechanism of NH₃ gas into water stream.
3. The gaps between the adjacent tubes are kept as small as possible enough not to touch each other. Such gaps are enough wide for the air to pass through the tubes without any significant resistance to the flowing of the forced air through the tubes owing to disturbings of the tubes for air to flow transversely through the scrubber, so that a low pressure drop of the air passing through the scrubber is established over the scrubber and the contacting surfaces of air and water becomes to be maximized.

The components comprised in the tube-screen-scrubber device and the trapezoidal-duct assisting poultry AHD removal system are described as follows.

<Tube-Screen-Scrubber Device and NH₃ gas Removal Process> The tube-screen-scrubber device is schematically shown in FIG. 1, consisting a tube-screen-scrubber pack shown in FIG. 2, working solution supplying box shown in FIG. 4, working solution collection sump shown in FIG. 5, and open-box-shape supporter shown in FIG. 5-1. To assemble the working solution supply box and working solution collection sump respectively on the top and bottom plates of the tube-screen-scrubber pack, the open-box-shape supporter shown in FIG. 5-1 is firstly attached on the rim of the working solution collection sump as shown in FIG. 5-2 and then the tube-screen-scrubber pack is inserted into the open-box-shape supporter attached on the working solution collection sump by sliding down through the open top of the open-box-shape supporter attached on the sump. Next, the working solution supply box is inserted into the open-box-shape supporter down onto the top of the tube-screen-scrubber pack inserted in the open-box-shape supporter attached on the sump shown in FIG. 5-2 to fabricate the tube-screen-scrubber device shown in FIGS. 1 and 1-1. The tube-screen-scrubber device has a function of contacting of the air and working solution. The contacting of the air and working solution occurs on the surfaces of the tubes vertically suspended in the tube-screen-scrubber pack. The working solution supplying box is schematically drawn as shown in FIG. 4, which is in the shape of flat square box consisting of cover plate with working solution supplying port on top as shown in FIG. 4-1 and bottom mesh net with a working solution uniform distributer placed on the mesh net as shown in FIG. 4-2. The working solution collection sump shown in FIG. 5 is in the shape of flat square box with open top and upper rim of the sump able to be fit with the bottom square plate of the tube-screen-scrubber pack as shown in FIG. 1, which shows the placing of the bottom square plate of the tube-screen-scrubber pack on the upper rim of the sump. Also the rim is made up not to leak working solution from the joining part surrounding between the bottom plate of the tube-screen-scrubber pack and working solution collection sump. A working solution outlet port discharging the working solution from the sump is provided on the bottom plate of the sump as shown in FIG. 5. When the tube-screen-scrubber device is operated, the working solution is supplied into the working solution supply box through the working solution inlet port on the working solution supplying box cover and then passes through the working solution uniform distributer on the bottom of the working solution supplying box into the tube-screen-scrubber pack through the top ring-shaped hole perforated plate of the tube-screen-scrubber pack. The working solution passed uniformly through the top perforated plate flows down on the surfaces of the tubes vertically suspended between the top and bottom perforated plates. While the working solution flowing down on the surfaces of the tubes, the working solution contacts with the exhausted air stream transversely blowing throughout the tube-screen-scrubber pack by the ventilation fan to transfer the NH₃ gas contaminated in the exhausted air stream into the working solution through the interfaces of the air and working solution on the surfaces of the tubes. The NH₃ gas dissolved in the working solution immediately converts to NH₄⁺ in the working solution so that the working solution becomes an NH₄⁺ working solution. Such dissolving process of the NH₃ gas into the working solution continues until the working solution and air stream completely passes the tube-screen-scrubber pack. The clean air stream passed out through the tube-screen-scrubber device discharges into the environments and the NH₄⁺ working solution passed out through the bottom perforated plate of the tube-scree-scrubber pack is collected in the working solution collection sump.

<Fabrication of Tube-Screen-Scrubber Pack> The tube-screen-scrubber pack equipped in the tube-screen-scrubber device of the present invention is schematically illustrated in FIG. 2, which is a standard tube-screen-scrubber pack in a shape of a square-box to be connected with medium-size ventilation fans. The standard tube-screen-scrubber pack comprises top and bottom ring-shaped-hole perforated plates and a plurality of tubes which are vertically suspended and fixed through the holes on the top and bottom perforated plates of the tube-screen-scrubber pack. The ring holes on the top and bottom perforated plates are positioned on the same locations and lined up transversely to the air flowing direction and also they are arranged in zigzag shapes along the air flowing direction. The square-box-shaped tube-screen-scrubber pack is fabricated by assembling of a plenty of plate-shaped tube-screen-scrubbers shown in FIG. 3. The plate-shaped tube-screen-scrubber and tube-screen-scrubber pack are same with the plate-shaped tube-screen-fill and box-shaped tube-screen-fill pack invented by the present inventor for using in the cooling tower to replace the current coiling tower film fills. The plate-shaped tube-screen-fill is fabricated by a plastic injection mold. The detailed descriptions of fabricating the plate-shaped tube-screen-fill are referred to the U.S. Pat. No. 10,046,502 B2 and application Ser. No. 17/401,195. The fabrications of the plate-shaped string-screen-fill (scrubber) are referred to the U.S. Pat. No. 8,973,908 B2, and rod-screen-fill (scrubber) referred to U.S. application Ser. No. 13/888,327.

<Brief Description of Plate-Shaped Tube-Screen-Scrubber and Tube-Screen-Scrubber Pack Based on Patented Tube-Screen-Fill and Tube-Screen-Fill Pack Invented by Present Inventor> The plate-shaped tube-screen-scrubber is in a shape of a rectangular plate like a string curtain of commercial product as shown in FIG. 3, consisting of a number of tubes lined up along the longitudinal axes of frames are placed at regular spacing between the adjacent tubes along the ring-shaped hole perforated frames. The tube near the edge of the plate-shaped tube-screen-scrubber frame is apart from the edge of the frame by ¼ tube regular spacing (interval between adjacent tubes on the longitudinal axis of the ring-shaped hole perforated frame), while the one near the other side edge apart by ¾ tube regular spacing, and the other tubes in the middle frame are apart from each other at the regular spacing as shown in FIG. 3. Such arrangement of the tubes on the longitudinal axis of the plate-shaped tube-screen-scrubber provides the ring-shaped holes and tubes to be arranged in zigzag arrangements on the ring-shaped hole perforated plates and in the tube-screen-scrubber pack, respectively, as shown in FIG. 2, when a plenty of the plate-shaped tube-screen-scrubbers are assembled to fabricate the tube-screen-scrubber pack by assembling side by side of the plate-shaped tube-screen-scrubbers with horizontally rotating of every other plate-shaped tube-screen-scrubbers by 180 degree.

<Description of Structural Configuration of the Tube-Screen-Scrubber Pack> The tube-screen-scrubber pack is schematically drawn as shown in FIG. 2, which provides a low pressure drop, large specific surface area, and water uniformly distributed on the surfaces of the tubes vertically suspended in the tube-screen-scrubber pack. The tube-screen-scrubber pack is made of one piece of structured packing, whose fabrication is described in the section of <Fabrication of Tube-Screen-Scrubber Pack>. The structural configuration of the tube-screen-scrubber pack fabricated with tubes as shown in FIG. 2 is simply drawn as shown in FIG. 6, which is a partial drawing picture of the top cross section of the tube-screen-scrubber pack showing a configuration of tubes in a zigzag shape (staggered) arrangement. The zigzag arrangement of the tubes helps the flowing air to consecutively contact with water flowing down on the round surfaces of tubes by passing through the zigzag-arranged tubes without being obstructed by the tubes until the air has completely traveled out of the tube-screen-scrubber device. Likewise, the tube-zigzag-arrangement maximizes the contacting efficiency of the air and water on the round surfaces of tubes in the tube-screen-scrubber pack and provides a low pressure drop of the flowing air passing throughout the tube-screen-scrubber device without blocking, resisting, and obstructing of the air passing through the zigzag-arranged round tubes. The tubes are vertically suspended between the top and bottom ring-shaped hole perforated plates of the tube-screen-scrubber pack as shown in FIG. 2. The air stream passes transversely through the vertical tubes suspended in the tube-screen-scrubber pack. The vertical round tubes do not block nor obstruct the flowing of air passing surrounding the round surfaces of the vertical tubes because the round tube surfaces help the air to pass through the vertical tubes by sliding on the round surfaces of the vertical tubes following directions of air flowing lines as shown in FIG. 6. When the air passing through the vertical tubes arranged in the zigzag configuration in a precisely engineered tube-screen-scrubber pack hits the vertical tubes, the flowing air smoothly passes by sliding over the round surfaces of the vertical tubes accompanied by vertical flows helping to maximize contacting air and water on the surfaces of the tubes, as shown in FIG. 6, without head-on colliding on the vertical round tubes or obstructing flowing of air, while a head-on collision of flowing air on the walls of not-organized air-passageways in the random packing is inevitable to obstruct or block flowing of air to increase the pressure drop of the air flowing throughout such scrubbers. Such a pattern of air flowing through the precisely organized tube-screen-scrubber pack does not significantly resist the flowing of air through the tube-screen-scrubber pack so that the pressure drop of the flowing air is expected to be significantly low. Consequently, although the high speed of air passing through the tube-screen-scrubber pack, the pressure drop of flowing air is not significantly as high as in the random packing scrubber. The flowing patterns of air flowing transversely through the vertical-tubes are changed as the diameters of the tubes and gaps between the adjacent vertical-tubes are changed, leading to change the specific surface area (SSA), void fraction, and pressure drop of the tube-screen-scrubber pack. The variations of the SSA of the tube-screen-scrubber pack depending on the diameters of the tubes and gap-distances between adjacent vertical-tubes are shown in FIG. 7, which shows that the largest SSAs of the tube-screen-scrubber pack are formed at the tube diameters of 0.25-0.35, 0.35-0.45, and 0.4-0.5 ft for gab-distances of 0.25, 0.3, and 0.435 ft, respectively. The specific surface areas 23.5 and 22.2 ft²/ft³ whose outside diameter (OD) of tubes are 0.2 and 0.875 ft, respectively, marked on FIG. 7 are experimental data having proved that a string-screen-scrubber made of using strings of diameter 0.2 ft successfully removed NH₃ gas discharged from the storage facility of livestock manure and that tube-screen-scrubber pack using tubes of OD 0.876 ft provided 30% higher cooling efficiency of hot water cooling compared with that of the PVC film cooling media used in current cooling tower when the tube-screen-scrubber pack was used as tube-screen-fill for cooling water. FIG. 7 shows three zones of strings, rods, and tubes which are grouped by their diameters of strings less than 0.2 ft, rods between 0.2 ft and 3.5 ft, and tubes greater than 3.5 ft, respectively. The tube-screen-scrubber pack does not use smaller tubes than the smallest tube size, 3.5 ft in OD, to be used in the tube-screen-scrubber pack, since the fabrication cost of the small tubes is high. So, the tubes smaller than the smallest tube size of OD 3.5 ft are replaced with rods between 0.2 ft and 3.5 ft in OD and the rods smaller than 0.2 ft replaced with strings. A method to select a right material for screen-scrubber is to select the material to provide a higher SSA and lower fabrication cost for selected conditions using the data shown in FIG. 7. The main reason of employing tubes in the scrubber is a reduction of plastic wastes and scrubber fabrication cost. The variations of void fractions of the tube-screen-scrubber pack versus the diameters of the tubes and gap-distances between adjacent vertical-tubes are shown in FIG. 7-1, which shows that the void fractions of the screen-scrubber packs increase due to decreasing of diameters of the screen-scrubber packed materials and gap distance between the screen-scrubber packed materials. The void fraction of the tube-screen-scrubber pack using tubes of 0.875 ft in OD and their gap distances of 0.435 inches is 59% and that of the string-screen-scrubber pack using strings of 0.2 ft in diameter and gap of 0.435 inches 90%, which are obtained from FIG. 7-1. From these information and prototype experimental results described above, it is understood that a much higher efficient tube-screen-scrubber pack can be made of by using of smaller diameter tubes and shorter gaps between the adjacent tubes, since the tube-screen-scrubber pack used in the prototype experiment has a large void space and significantly low pressure drop.

<Corrugated Surfaces of Tubes Used in Plate Shaped Tube-Screen-Scrubber> The tubes used in the present invention are spiral corrugated tubes with spiral wavy corrugated surfaces. The spiral corrugated surface forms waves repeating humps and grooves whose flute directions are slanted to the longitudinal length of the tube. The slant angle, 30 degree, of the corrugated flute is preferred in the present invention. Such perforated profile of tube surface offers stronger tube in any thin gauge thickness and large surface area of contacting water and air, and spiral corrugated surface increases the contacting time of water and air due to longer flutes for water to pass on the surface area. Hence, the spiral corrugated tubes are preferred in the present invention. More detailed explanation of the corrugated tubes is referred to the U.S. Pat. No. 10,046,502 B2.

<Effect of Staggered Arrangement of Tubes in Tube-Screen-Scrubber Pack> Since the vertical tubes installed in the tube-screen-scrubber are arranged in the staggered configuration as shown in FIG. 6, the vertical tubes bifurcate air streams approaching the front sides of the vertical tubes into outer- and inner-layer air streams which continuously flow over the adjacent tubes positioned on slanted lines at upper and lower incidence angle 30° to the forward direction of the flowing air stream as shown in FIG. 6. While such processing occurs, the outer-layer air streams mix with adjacent inner-layer air streams generated from the adjacent tube lined up on the same row of the tubes and also the inner-layer air streams mix with adjacent outer-layer air streams as shown in FIG. 6, which mixing processes of air stream layers are accomplished due to staggered arrangement of tubes. Those type of flowing air streams continue while the air stream is completely passed out of the pack. The velocity of the air stream being processed in the tube-screen-scrubber device is in the range of 400-600 ft/min. The air streams before entering into the tube-screen-scrubber pack are in nonturbulent flows (smooth flows). However, when the smooth flowing air streams start to flow through the bundle of tubes in the tube-screen-scrubber, their smooth flows are changed into the turbulence flow due to tubes arranged in the staggered configuration. In the turbulent flow, the drags between adjacent layers of air streams and between the air streams and their surroundings (vertical tubes) form eddies and swirls in the turbulent air streams and the layers of air streams locally mix together via eddies and swirls of air streams. As a result, the flow paths of air streams are mixed each other over all within the tube-screen-scrubber pack. Due to turbulent flow of the air streams passing through all vertical tubes, significant contacting of the fresh bulk air streams with the surfaces of the working solution flowing down over the tubes occur surrounding the entire tubes in the tube-screen-scrubber pack and therefore most of NH₃ gas contaminated in the fresh bulk air streams transfer through the interfaces of air and water into the working solution flowing down over the all tubes to maximize the NH₃ gas removal efficiency of the tube-screen-scrubber device. And also such contacting of air streams and working solution over the round surfaces of vertical tubes occur over the whole surfaces of the vertical tubes throughout the tube-screen-scrubber pack to maximize the SSA of the tube-screen-scrubber device. In addition, the air streams flow in a free flowing pattern without any blocking, resisting, or obstructing of obstacles except for round vertical tubes, so that the air streams provide a lower pressure drop from air stream inlet side to outlet side across the tube-screen-scrubber pack. Those advantages (Generation of full turbulence flow, Maximizing SSA, Lower pressure drop, Maximizing removal efficiency of NH₃ gas) of the tube-screen-scrubber pack for removing of the NH₃ gas contaminated in the air stream are secured due to utilizing of the structured packing tube-screen-scrubber having proved its capability of cooling water by obtaining 30% higher water cooling efficiency compared to that of the current cooling tower PVC film-fill pack in spite of having a half of SSA, 55 ft²/ft³, of the current PVC film-fill pack as described in the section of <Evaluation of Tube-Screen-Scrubber from Testing Results of Tube-Screen-Fill Pack and PVC Film-Fill Pack Using Prototype Water Cooling Tower>. The reasons why the tube-screen-scrubber pack having smaller SSA compared to the PVC film-fill pack secures a higher water cooling efficiency are described as follows. The efficiency of water cooling or NH₃ gas removing of the tube-screen-scrubber pack is primarily proportional to the extent of the SSA of the packed materials and other positive-effective factors to their efficiencies are a generation of the turbulence flows of the air streams, horizontally mixing of air streams, and uniformly flowing down of the air streams over the entire surfaces of the packed materials. However, major negative-effective factor to their efficiencies is an obstruction of obstacles to flowing of air streams throughout the pack. The PVC film-fill pack is made of by joining side by side of corrugated PVC film plates attached by a plenty of push button connectors provided on both side surfaces of the film plates. The push button connectors connected the plates obstruct flowing of the air streams passing through between the plates and also the air streams flowing through narrow spaces formed between the plates are resisted by plate surfaces throughout the pack. Such structural obstructions of the PVC film-fill pack to the flowing of the air streams cause a high pressure drop of the air streams compared to the Tube-screen-scrubber pack. Another drawback of the PVC film-fill pack is that the horizontal mixing of the air streams through the pack being occurred within the tube-screen-scrubber pack is blocked by the PVC film-plates within the PVC film-fill pack. The Reynolds Number of air stream within the PVC film-fill pack is in the range of 6000-7500 and so the flow of air stream passing through the air-stream-flowing-channel formed between the PVC film-fill plates is in a full turbulence flow such as the flow of air stream in the tube-screen-scrubber pack is in the full turbulence flow. Based on the comparative reviewing of the tube-screen-scrubber pack with the PVC film-fill pack above, it is concluded that the tube-screen-scrubber pack fabricated with tubes in the staggered arrangement is a perfect scrubber module for removing NH₃ gas from the NH₃ gas contaminated air streams.

<Calculation of Reynolds Number of Air Stream within Tube-Screen-Scrubber Pack> To understand the extent of the turbulence flow, the Reynolds Number of the air streams flowing through the tube bundles in the tube-screen-scrubber pack is calculated as follows. The characterization of the such flowing air stream past through the tube bundles in the tube-screen-scrubber pack is presumed by Reynolds Number calculated using the definition of Re=ρvDh/μ and Dh=4A/P, where ρ is a density of air stream in kg/m³, v is a velocity of air stream in m/sec, μ is a dynamic viscosity of air stream in kg/msec, and Dh is a hydraulic diameter of a dark-marked cross sectional area, A, of a channel of air stream made of by three adjacent tubes as shown in FIG. 6, which hydraulic diameter is calculated from 4 times A divided by total wetted perimeter, P, of the three wetted surfaces of the dark-marked channel [6]. The dark-marked cross section area, A, is calculated by subtracting a half area (0.000193 m²) of tube cross section area from a regular triangle area (0.00048 m²) whose side length is a pitch, 1.31 inches (0.0333 m), between center points of adjacent tubes (tube outside diameter is 0.875 inches (0.0222 m)), and then A is obtained to be 0.000287 m². Total wetted perimeter P is equal to 3.14×tube outside diameter, d, divided by 2, which is 0.034854 m. Substituting A and P into Dh=4A/P, the hydraulic diameter Dh is obtained to be 0.03294 m. Now, Reynolds Number can be calculated using the properties of air at 1 atm pressure, ρ=1.164, 1.246 kg/m³ at 30° C., 10° C., μ(dynamic viscosity)=1.872×10⁻⁵, 1.778×10⁻⁵ at 30° C., 10° C., and v=500 ft/min (2.54 m/sec) of air stream in the tube-screen-scrubber pack. Computed Reynolds Numbers are 5196 at 30° C. and 5828 at 10° C. Thus, the Reynolds Number of the air stream flowing through the tube bundles in the tube-screen-scrubber device is in the range of 5000-6000, which are greater than Reynolds Number of 4000 at which the full turbulent flow of air stream occurs [7], so that the air stream flowing in a velocity of 500 ft/min through the tube-screen-scrubber pack is in the full turbulent flow.

<Comparison of Packing Beds Employed in Honeycomb-shape Scrubber and Tube-Screen-Scrubber Pack> The honeycomb-shape scrubber packing bed consists of a plurality of tunnels tangled together. Hence, the tunnels are usually not straightly arranged so that the air flowing through the tunnels tangled each other collide with lots of bent parts of the tunnels to resist or to obstruct the flowing of air through the tunnels. As a result, the pressure drop of the flowing air is expected to be high. However, the engineered structural configuration of the tube-screen-scrubber pack fabricated with tubes shown in FIG. 2 is simply drawn as shown in FIG. 6, which is a partial drawing picture of the cross section of the tube-screen-scrubber pack showing a configuration of tubes in a zigzag-shape arrangement. And also FIG. 6 shows that there is a void space free of obstacles tangled between tubes to flowing air through the tube-screen-scrubber pack, since the tubes are vertically suspended between the top and bottom plates of the tube-screen-scrubber pack as shown in FIG. 2. As shown in FIG. 6, the air stream passes transversely through the tubes in the tube-screen-scrubber pack. The tubes do not block the flowing of air passing surrounding the round surfaces of the tubes because the round tube surfaces help the air to pass the tubes by sliding and following arrow directions over the round surfaces of the tubes as shown in FIG. 6, but the tubes resist the flowing of the air to slightly affect the pressure drop of the flowing air owing to changing of the direction of flowing air. When the air passing through the tubes meets tubes, the air slippery passes over the round surfaces instead of colliding head-on the surfaces of tubes like colliding of fluid on the bent parts of pipe. Such a pattern of air flowing does not significantly resist the air flowing through the tube-screen-scrubber pack so that the pressure drop of flowing air is expected to be significantly low. Even though the higher speed of air passing through the tube-screen-scrubber pack, the pressure drop of flowing air is not significantly high as high in the honeycomb-shape packing bed. For the structured packing scrubber using large pieces of scrubbing materials like a honeycomb-shape packing bed, the higher is speeding of the air flowing through the structured packing scrubber, the higher significant pressure drop of the air is inevitable, since the resistance of the tunnels tangled each other against flowing air in the structured packing bed get stronger. The similar results are obtained for the random packing scrubber when the high speeding air passes through the random packing. But, the pressure drop of flowing air passing through the tube-screen-scrubber pack is not significantly high.

<Fabrication of Poultry H₂S Adsorber and Poultry Dust Filter Devices> The H₂S adsorber device is schematically drawn as shown in FIG. 9. The rear and front square mesh plates of the H₂S adsorber device are in the same sizes to fit with the front side of the tube-screen-scrubber pack equipped in the tube-screen-scrubber device and the rear side of the dust filtering device, respectively. Both square mesh plates of the H₂S adsorber device consist of mesh holes smaller than adsorbent pellets for air to get into and out of the device and to hold H₂5 adsorbent pellets loaded in the device as shown in FIG. 9. The H₂S adsorbent pellets are commercially available and have a high removal efficiency of the H₂S gas from the H₂S contaminated air stream which can remove H₂S pollutants down to less than 1 ppm. The poultry dust filter device has two objectives, removal of pathogenic dust-particles carrying various kinds of pathogens for protection of local residential healths and dust-particles themselves to be harmful to the operation of the hydrogen sulfide adsorber and NH₃ gas removal tube-screen-scrubber devices. Since the exhaust air stream emitted from poultry production facilities contains various sizes of poultry dusts, three kind of filters of large poultry dust particle filter, medium dust-particle filter, and fine dust-particle filter are employed to improve the filtering performances of the filters and to use each of the filters for as long as possible. To achieve this, the dust filter device is designed to consecutively insert three different filters into the dust filter device and to easily remove out them for replacing with new ones as shown in FIG. 10. Hence, the three filters are individually replaced with a new filter depending on their filtering capabilities. The large poultry dust-particles are firstly filtered by passing the front large dust-particle filter from the contaminated air stream before the contaminated air stream enters the medium dust-particle filter to prevent clogging next filters, so that the large dust-particle filter is inserted into the front filter box of the dust filtering device. Next, medium dust-particle filter is inserted in the middle filter box and the fine dust-particle filter in the rear filter box as shown in FIG. 10. If the contaminated air stream enters the filter device consisting of one kind filter without filtering the large and medium dust-particles in their stages from the air stream, the unfiltered dust-particles in contaminated air stream clog up the pores of H₂S absorber and are trapped by a circulating working solution (e.g. working solution is defined as an acid water used in a wet scrubber, which includes hydrogen ion (H⁺) made up by adding HCl solution in water) flowing down on the surfaces of the tubes in the NH₃ gas scrubber device and also the one kind filter device loses quickly its dust filtering capability. What is more serious due to not-filtering of relatively large and medium dust before entering the poultry AHD removal system is that the trapped dusts in the circulating working solution clog up the working solution circulation pipe and ion exchanger column in the poultry AHD removal system. Therefore, all of dusts must be removed before entering the poultry AHD removal system. To remove such dusts from the exhausted air stream, the dust filtering device is attached to the front of the H₂S scrubber device as shown in FIG. 11. When the filters are needed to be changed with new ones, the whole filter device in the equipment is drawn out from the poultry AHD removal equipment and the old ones are replaced with new ones.

<Standard Poultry AHD Removal Equipment and System> The schematic drawing of the poultry NH₃ gas removal equipment is illustrated as shown in FIG. 8, which is a standard poultry NH₃ gas removal equipment, comprising the standard NH₃ gas removal tube-screen-scrubber device, H₂S gas adsorber device, and dust filter device. The standard NH₃ gas removal equipment uses a small ventilation fan (e.g. fan blade size: 30″, flow rate: 5500 ft³/min at zero static pressure, speed of air at 0.1 static pressure: 500 ft/min), whose allowable flowing speed of air stream passing through the standard NH₃ gas removal tube-screen-scrubber is around 500 ft/min at static pressure 0.1. The schematic picture of the standard poultry AHD removal system is illustrated in FIG. 11, which is installed at the poultry litter storage, comprising the standard poultry AHD removal equipment, ventilation fan, and auxiliary system. The ventilation fan is attached on the clean air outlet side of the tube-screen-scrubber device in the poultry AHD removal equipment. The auxiliary system is connected to the poultry AHD removal equipment by connecting the outlet and inlet working solution circulation pipes of the auxiliary system to the working solution inlet and outlet ports of the tube-screen-scrubber device in the poultry AHD removal equipment, respectively, as shown in FIG. 11. The auxiliary system circulates the working solution by passing through the tube-screen-scrubber device equipped in the standard poultry NH₃ removal equipment, working solution supplying outlet circulation pipe connected to the auxiliary system, and working solution returning inlet circulation pipe connected to the auxiliary system by operation of the working solution circulation pump in the auxiliary system. Likewise, while the working solution circulates through the tube-screen-scrubber device, the ventilation fan blows the NH₃ gas contaminated air stream into the tube-screen-scrubber device in the standard poultry AHD removal equipment to contact with the working solution flowing down on the surfaces of the vertical tubes in the tube-screen-scrubber device. Thus, the NH₃ gas in the NH₃ gas contaminated air stream is transferred into the working solution through the interface between the air stream and working solution which process occur on the surfaces of the tubes while contacting air and working solution within the tube-screen-scrubber device, and then the NH₃ gas contaminated air stream becomes clean air stream which ventilates out from the poultry litter storage to the environments. The functions of the components consisted in the auxiliary system are described in the section of <Operation of the Trapezoidal-Duct Assisting Expanded Poultry AHD Removal System Installed at Huge Poultry House>.

<Adjustment of Standard Poultry AHD Removal Equipment into Expanded Poultry AHD Removal Equipment> The tube-screen-scrubber pack equipped in the tube-screen-scrubber device invented in the present invention uses an air velocity of 500 ft/min which is a safe velocity of air passing transversely through the tube-screen-scrubber pack without flying away of water flowing down over the round surfaces the tubes in the tube-screen-scrubber pack (a safe velocity of 500 ft/m of air flowing in the tube-screen-scrubber pack has been verified by using prototype experiments). But the velocity of air blowing out through the ventilation fan from the poultry house is high in a range of 1300-1500 ft/min (fans size 50-54″ and flow rates 17,800-23,000 ft³/min). Hence, the standard poultry AHD removal equipment connected to the ventilation fan (fan size 30-50″, flow rates 5,500-8000 ft³/min, air velocity 300-500 ft/min) installed at the enclosed litter storage or small size poultry houses as shown in FIG. 11 cannot be connected to a ventilation fan (fan size 50-54″, flow rate 17,800-23,000 ft³/min, air velocity 1300-1500 ft/min) employing at the large poultry house. So, the standard poultry AHD removal equipment delivering a flow rate of 5,500-8000 ft³/min in air velocity of 500 ft/min is necessary to be adjusted to deliver a flow rate of 17,800-23,000 ft³/min in a same air speed passing through the adjusted poultry AHD removal equipment. To achieve this, the standard poultry AHD removal equipment is enlarged to the expanded poultry AHD removal equipment by following enlarging directions as shown in FIG. 12. For determination of the enlarged dimension of the expanded poultry AHD removal equipment, the mass continuity equation of fluid flowing through two different cross sections is employed to be set as follows,

Flow rate of fluid×m=A₁×V₁×m=A₂×V₂×m (3),

where A, V, and m are an air-passing-cross-section, velocity of fluid, and mass of fluid, respectively, and subscript numbers 1 and 2 are a large cross section 1 of the equipment and small cross section 2 of the ventilation fan, respectively. Hence, from FIG. 12, the cross section A₁ of the expanded AHD removal equipment for delivering of 23,000 ft³/min of NH₃ gas in velocity V₁ of 500 ft/min is determined from the mass continuity equation of 23,000 ft³/min×m=A₁×500 ft/min×m. The cross section A₁ of the expanded AHD removal equipment is 46 ft², which is obtained by dividing 23,000 (ft³/min m) with 500 (ft/min m). The cross section 46 ft² is defined as height×width of the expanded AHD removal equipment. The cross section area of the expanded tube-screen-scrubber equipped in the expanded AHD removal equipment needs to be close to a square cross section, which is the best condition for forming an uniform velocity of the NH₃ gas passing the NH₃ gas outlet cross section of the expanded tube-screen-scrubber, so that the height×width of the cross section 46 ft² is determined to be 7(H)×6.6(W) ft² equal to 46.2 ft². The width of 6.6 ft is determined for total cross sections of the 10 units of the expanded poultry AHD removal equipment to evenly fill the end side wall, 10(H)×6.6(W) ft², of the large poultry house 10(H)×66(W)×600(L) ft³. The height of the expanded tube-screen-scrubber pack is chosen to be 7 ft for satisfying the equation of H×6.6 ft=46 ft². Based on the determined air outlet cross section of 7(H)×6.6(W) of the expanded tube-screen-scrubber pack, the dimensions of the expanded square-box-shaped tube-screen-scrubber or flat square-box-shaped equipped in the expanded poultry AHD removal equipment are determined to be in 7(H)×6.6(W)×6.6(D) or 7(H)×6.6(W)×3.3(D), respectively.

<Determination of Expanded Poultry AHD Removal Equipment> The determined air outlet cross section of 7×6.6 ft of the expanded AHD removal equipment can make the expanded AHD removal equipment to be a square box of 7(H)×6.6(W)×6.6(D) or flat square box of 7(H)×6.6(W)×3.3(D). The depth length of the expanded tube-screen-scrubber pack is determined by depending on testing results of NH₃ gas concentration in air stream obtaining through a prototype testing of NH₃ gas removal equipment thickness (Depth). The expanded tube-screen-scrubber pack is in a shape of a square box or flat square box owing to the determined thickness of the expanded NH₃ gas removal equipment. Now, the cross section of the square box-shape expanded tube-screen-scrubber pack is determined to be 7(H)×6.6(W) ft², through which the amount of 23,000 ft³/min of NH₃ gas is passed in a speed of 500 ft/min. This 7(H)×6.6(W) ft² is acceptable because its height is lower than wall height of the poultry house. The determined expanded tube-screen-scrubber is in a square-box or flat square-box shape of 7(H)×6.6(W)×6.6(D) or 7(H)×6.6(W)×3.3(D), respectively. The H₂S adsorber device shown in FIG. 9 and dust filter device shown in FIG. 10 equipped in the standard poultry AHD removal equipment shown in FIG. 8 are expanded to the same size of the determined expanded tube-screen-scrubber pack and the air outlet expanded cross section of the H₂S absorber plus the dust filter device is attached on the air inlet cross section of the determined expanded tube-screen-scrubber pack as shown in FIG. 12. As the air outlet cross section, 46 ft² computed from 7(H)×6.6(W) ft², of the expanded poultry AHD removal equipment is 3 times (e.g. 46 ft² divided by 16 ft² equal to 2.875 close to 3) larger than fan cross section of ventilation fan (cross section of a fan, 16 ft² computed from (4.5 ft/2)²×3.14) used in the medium and large poultry houses, they are not directly combined. To connect the expanded poultry AHD removal equipment to the square cross section of the ventilation fan, a square trapezoidal-duct with a trapezoidal-duct base (expanded cross section of the scrubber, 7(H)×6.6(W) ft²) and trapezoidal-duct top (small cross section of ventilation fan, 4.5(H)×4.5(W) ft²) and height of 6.6 ft (arbitrarily decided) between trapezoidal-duct base and top is determined as shown in FIG. 12-1 (shapes of arrows: arrow spaces within the arrows are same which means same flow rate of 23,000 ft³/min and arrow lengths different which means different speed of 500 and 1500 ft/min at the cross sections of 61 and 60) and inserted between the expanded poultry AHD removal equipment and ventilation fan by attaching the trapezoidal-duct base and top of the square trapezoidal-duct on the air outlet square cross section of the expanded poultry AHD removal equipment and small square cross section of the ventilation fan as shown in FIG. 12-2, respectively. FIG. 12-2 shows a square trapezoidal-duct assisting expanded poultry AHD removal equipment consisting the expanded poultry AHD removal equipment, square trapezoidal-duct, and ventilation fan, which is called the trapezoidal-duct assisting expanded poultry AHD removal equipment. Hence, the air speed of 500 ft/min passing the air outlet cross section of the expanded poultry AHD removal equipment is accelerated to 1500 ft/min at the inlet cross section of the ventilation fan due to a speed acceleration effect of the trapezoidal-duct while the air is passing through the trapezoidal-duct to be blown out through the ventilation fan to the environments. As a result of employing the trapezoidal-duct for combing the standard poultry NH₃ gas removal equipment and large ventilation fan, the trapezoidal-duct solves the problem of the standard poultry NH₃ gas removal equipment unable to be used for combining with the large ventilation fan due to a high speed of air flowing out through the ventilation fan, which speed is not allowable in the standard poultry NH₃ gas removal equipment.

<Square Trapezoidal-Duct> Most important factor to fabricate a square trapezoidal-duct is to make velocities of air stream traveling through the cross section of the trapezoidal-duct as uniform as possible. To reduce different velocities of the air passing through the cross section (usually, a central velocity of air is higher than side velocity and needs) of the trapezoidal-duct, the cross section needs to be close to a square cross section, referring to the section of <Adjustment of Standard Poultry AHD Removal Equipment into Expanded Poultry AHD Removal Equipment> and the height between the trapezoidal-duct base (large inlet cross section side) and trapezoidal-duct top (small outlet cross section) of the square trapezoidal-duct is as long as possible (to reduce a strong effect of fan-air-blowing-force to central cross section air speed in the duct). To meet such conditions of the square trapezoidal-duct, the square trapezoidal-duct is in a shape of a square duct reducer of commercial products consisting of air inlet large square cross section, air outlet small square cross section, and a square duct reducer between them as shown in FIG. 12-1, which has a function of accelerating the velocity of air passing through the square trapezoidal-duct. To accelerate the air speed of 500 ft/min at the air outlet large cross section of the expanded poultry AHD removal equipment to 1500 ft/min at the inlet small cross section of the ventilation fan, the square trapezoidal-duct is fabricated by equalizing its air inlet and outlet cross sections with the air outlet cross section 7(H)×6.6(W) ft² of the expanded poultry AHD removal equipment and air inlet cross section 4.5(H)×4.5(W) ft² of the ventilation fan, respectively. The height between the air inlet and outlet cross sections of the square trapezoidal-duct is randomly chosen to be 6.6 ft to make the square trapezoidal-duct in a medium size, although a much longer height is necessary to reduce a strong effect of air-blowing-force to central air speed at the outlet large cross section of the expanded poultry AHD removal equipment. Then, the dimension of the square trapezoidal-duct are 7(H)×6.6(W) ft², 4.5(H)×4.5(W) ft², and 6.6 ft for the square trapezoidal-duct base and top, and height of the square trapezoidal-duct, respectively.

<Trapezoidal-Duct Assisting Expanded Poultry AHD Removal System> The trapezoidal-duct assisting expanded poultry AHD removal system 82 is schematically illustrated as shown in FIG. 13, comprising the expanded poultry AHD removal equipment shown in FIG. 12, trapezoidal-duct, ventilation fan, and auxiliary system. The auxiliary system is connected to the expanded poultry AHD removal equipment by connecting the outlet and inlet working solution circulation pipes of the auxiliary system to the working solution inlet and outlet ports of the tube-screen-scrubber device shown in FIG. 1 equipped in the expanded poultry AHD removal equipment shown in FIG. 12, respectively, as shown in FIG. 13. The trapezoidal-duct assisting expanded poultry AHD removal system shown in FIG. 13 is a single unit fabricated by expanding the standard poultry AHD removal system shown in FIG. 11 and inserting the air-speed accelerating trapezoidal-duct shown in FIG. 12-1 between the expanded poultry AHD removal equipment shown in FIG. 12 and ventilation fan, as shown in FIG. 13. When the trapezoidal-duct assisting poultry AHD removal systems are installed in the large poultry house operating several ventilation fans, same number of units of the trapezoidal-duct assisting expanded poultry AHD removal equipments with number of ventilation fans are combined side by side to be assembled in the main system being operated under one auxiliary system as described in the section of <Installation of Trapezoidal-Duct Assisting Expanded Poultry AHD Removal System at Poultry Houses>.

### BRIEF DESCRIPTION OF THE DRAWINGS

FIG. 1 is a schematic drawing of the tube-screen-scrubber device comprising a tube-screen-scrubber pack, working solution supply box, and working solution collection sump on top and bottom of the tube-screen-scrubber pack. FIG. 1-1 shows the schematic cross section view of a cross section I-I of the tube-screen-scrubber device shown in FIG. 1. FIG. 2 illustrates a schematic picture of the tube-screen-scrubber pack which is in a shape of a square box or flat square box, consisting top and bottom ring-shaped hole perforated plates and a plurality of tubes vertically suspended to between top and bottom ring-shaped perforated plates, which is fabricated by assembling side by side of a number of plate-shaped tube-screen-scrubbers shown in FIG. 3. FIG. 3 schematically illustrates a picture of plate-shaped tube-screen-scrubber consisting top and bottom perforated frames and a plenty of tubes are suspended between the top and bottom perforated frames like a string curtain. FIG. 4 illustrates the schematic drawing of the cross section II-II of the water distribution box assembled by combining the water distributer cover shown in FIG. 4-1 and water containing box shown in FIG. 4-2. FIG. 5 shows a schematic picture of water solution collection sump with an open top and upper rem of the box and working solution outlet hole and port. FIG. 5-1 illustrates an open-box-shape supporter to safely hold the tube-screen-scrubber pack with the working solution supply box attached on top of the scrubber pack on the rim of the working solution collection sump. FIG. 5-2 shows a front section view of water collection sump attached the open-box-shape supporter shown in FIG. 5-1 on the upper rim of the working solution sump. FIG. 6 illustrates the top cross section view of the tube-screen-scrubber pack showing a configuration of tube arrangement in the tube-screen-scrubber pack. FIG. 7 shows variations of the specific surface areas of the screen-scrubber packs of three scrubbing materials, tubes, rods, and strings depending on the diameters of the materials and three zones of strings, rods, and tubes which are grouped by their diameters of strings less than 0.2 ft, rods between 0.2 ft and 3.5 ft, and tubes greater than 3.5 ft, respectively and FIG. 7-1 also shows variations of void fraction of the screen-scrubber packs vs diameters of the materials and three different gaps between the adjacent materials. FIG. 8 is a schematic drawing of standard poultry AHD removal equipment assembled by attaching dust filter and H₂S gas adsorber devices to the air inlet cross section of the NH₃ gas removal device. FIG. 9 is a schematic picture of H₂S gas adsorber device loaded a plurality of H₂S gas adsorbent pellets. FIG. 10 is a schematic picture of the dust filter device designed to consecutively insert three different filters into the dust filter device and to easily remove out them for replacing with new ones. FIG. 11 illustrates a schematic drawing of standard poultry AHD removal system installed on the side wall of litter storage. FIG. 12 shows a schematic drawing of showing how to enlarge the standard poultry AHD removal equipment to an expanded poultry AHD removal equipment and keeping 500 ft/min of air speed in the poultry AHD removal equipments before and after enlarging. FIG. 12-1 explains a mass continuity equation of air flowing through air speed acceleration trapezoidal-duct with arrows showing same arrow space area and different length indicating same flow rate and different air speed passing the different cross section area, respectively. FIG. 12-2 shows a schematic drawing of a square trapezoidal-duct assisting expanded poultry AHD removal equipment by inserting the square trapezoidal-duct between the expanded poultry AHD removal equipment and ventilation fan. FIG. 13 illustrates a schematic drawing of single unit square trapezoidal-duct assisting expanded poultry AHD removal system. FIG. 14 is a schematic view of installation of six square trapezoidal-duct assisting poultry AHD removal system at poultry house of 10(H)×40(W)×400(L). FIG. 14-1 is a schematic side view of poultry house showing one of six units of square trapezoidal-duct assisting expanded poultry AHD removal equipments installed on the side wall of poultry house of 10(H)×40(W)×400(L) ft³. FIG. 15 is a schematic picture of eighteen square trapezoidal-duct assisting expanded poultry AHD removal system including an auxiliary system installed in a huge poultry house of 10(H)×66(W)×600(L). FIG. 15-1 shows a side view of poultry house installing four units of trapezoidal-duct assisting poultry AHD removal equipments on the side wall and one of ten units installed on the end side wall of the huge poultry house of 10(H)×66(W)×600(L).

### DESCRIPTION OF NUMBERS IN THE DRAWINGS

1 tube-screen-scrubber device (poultry NH₃ gas removal tube-screen-scrubber device), 2 working solution inlet port, 3 inlet working solution distributer, 4 working solution supplying box cover, 5 working solution spray nozzle, 6 working solution uniform distributer, 7 steel mesh plate, 8 top ring-hole perforated plate with plugged tubes set in holes, 9 tube, 10 tube-screen-scrubber pack, 11 bottom ring-hole perforated plate, 12 working solution collection sump attached open-box-shape supporter, 12-1 open-box-shape-supporter, 12-2 side wall supporting tube-screen-scrubber, 12-3 plate bar supporter, 13 working solution outlet port, 14 rim, 15 working solution supply box, 16 ring-hole surrounding plugged tube, 17 plate-shape tube-screen-scrubber, 18 top ring-hole perforated frame, 19 plugged tube, 19-1 front side of plugged tube, 20 tubes row, 21 working solution distribution box with water solution uniform distributer on bottom, 22 working solution outlet hole, 23 pitch distance between tube-centers of adjacent tubes (equilateral triangle formed in the zigzag arrangement of tubes in packing bed), 24 distance between tube rows computed from using 1.7321×half of tube center interval, 25 gap between adjacent ring hole, 26 interval between adjacent tube surfaces, 0.435 inches, 26-1 a cross sectional area of a channel of air stream made of by three adjacent tubes in the tube-screen-scrubber, 27 direction of inlet-air flowing, 28 smooth flowing air stream before entering the tube-screen-scrubber pack, 28-1 and 28-2 inner- and outer-layer air streams flowing to the front side of the adjacent tube on slanted lines at respective lower and upper incidence angle 30° C. to the forward direction of the slowing air stream after passing through the round tubes, 29 standard poultry AHD removal equipment, 30 clean air outlet side of tube-scree-scrubber (standard poultry AHD removal equipment), 31 air inlet side of standard poultry AHD removal equipment (filter device), 32 filter device, 33 H₂S adsorber device, 34 H₂S adsorbent pellet box, 35 air outlet side of H₂S adsorber device, 36 front mash plate, 37 H₂S adsorbent pellets, 38 poultry dust filter device, 39 dust filter box, 40 air inlet side of poultry dust filter device, 41 large dust filter, 42 medium dust filter, 43 fine dust filter, 44 standard poultry AHD removal system, 45 working solution major system supply inlet circulation pipe (working-solution-major-system-inlet-circulation-pipe), 46 working solution major system returning outlet circulation pipe (working-solution-major-system-outlet-circulation-pipe), 47 two way valve, 47-1 three way valve, 48 small or medium size ventilation fan, 49 side wall of litter storage, 50 expanded poultry AHD removal equipment, 51 expansion line for increasing 4.5 ft height of standard equipment to 7 ft height of expanded equipment, 52 expanded filter device, 53 expanded H₂S adsorber device, 54 expanded (NH₃ gas removal) tube-screen-scrubber device, 55 expanded (NH₃ gas removal) tube-screen-scrubber pack, 56 clean air outlet side of expanded tube-screen-scrubber pack (expanded poultry AHD removal equipment), 57 air speed of 500 ft/min and air flow rate of 5500-8000 ft³/min, 58 air speed 500 ft/min and air flow rate 178,000-23,000 ft³/min, 59 square trapezoidal-duct, 60 trapezoidal top, 4.5(H)×4.5(W) ft², of square trapezoidal-duct, 61 trapezoidal base, 7(H)×6.6(W) ft², of square trapezoidal-duct, 62 height, 6.6 ft, of square trapezoidal-duct, 63 velocity and flow rate of flowing air entering the square trapezoidal-duct through large base cross section are 500 ft/min and 17,800-23,000 ft³/min, 64 velocity and flow rate of flowing air leaving the square trapezoidal-duct through small top cross section are 1300-1500 ft/min and 17,800-23,000 ft³/min, 65 large ventilation fan blowing of air speed 1300-1500 ft/min and flow rate of 17,800-23,000 ft³/min, 66 trapezoidal-duct assisting expanded poultry AHD removal equipment, 67 single unit main system of trapezoidal-duct assisting expanded poultry AHD removal system, 68 auxiliary system, 68-1 working solution inlet port of auxiliary system (auxiliary inlet port), 68-2 working solution outlet port of auxiliary system (auxiliary outlet port), 69 wet-fine-dust-filter cartridge, 70 auto-tap-water-valve, 71 working solution reservoir tank, 72 working solution circulation pump, 73 ion exchanger column, 74 phosphoric acid solution tank, 75 phosphoric acid solution supply pump, 76 monoam0nium phosphate salt (fertilizer) collection tank. 77 HCl solution tank, 77-1 HCl solution supply pipe, 78 HCl solution supply pump, 79 open and close valve, 80 trapezoidal-duct assisting expanded poultry AHD removal system (six units), 81 working solution distribution pipe, 82 main system of trapezoidal-duct assisting expanded poultry AHD removal system (six units) (main system), 82-1 main system outlet port, 83 picture reduction line, 84 trapezoidal-duct assisting expanded poultry AHD removal system (removal system) installed at huge poultry house of 10(H)×66(W)×600(L) (eighteen units), 84-1 major system (including three subsystems without auxiliary system), 85 subsystem, 85-1 subsystem outlet port, 86 four way controlling valve, 86-1 major system inlet port, 86-2 major system outlet port, 87 working solution subsystem supply pipe, 88 working solution subsystem supply port, 89 working solution subsystem outlet pipe attached to trapezoidal-duct assisting expanded poultry AHD removal system (eighteen units), 90 end-side-wall of huge poultry house of 10(H)×66(W)×600(L), 91 subsystem working solution collection sump, 92 side-wall of poultry house, 93 auxiliary circulation pipe-one, 94 auxiliary circulation pipe-two, 95 auxiliary circulation pipe-three, 96 auxiliary circulation pipe-four, 97 auxiliary circulation pipe.

### DESCRIPTION OF SPECIFIC TERMS USED

AHD: abbreviation of Ammonia gas, Hydrogen sulfide gas, and Dust-particles.

Cavity partial-mold 4: cavity partial-mold allows for PTSF cavity to be formed surrounding the cavity partial-mold by covering the upper and lower cavity partial-mold halves with the hollowed-out PTSF cavity halves on the inner surfaces of the upper and lower partial molds.

Hollowed-out tube cavity halves 43-1: tube cavity halves are hollowed-out on the inner surfaces of the molds, which are provided between the imaginary top and bottom frames.

Hollowed-out PTSF cavity half 43: plastic-tube-screen-fill cavity half is hollowed out on the inner surface of the mold.

Hollowed-out inner surfaces: Inner surface hollowed-out of the PTSF cavity halves on upper and lower partial-molds.

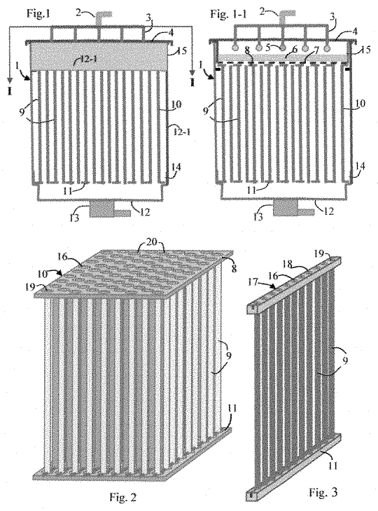

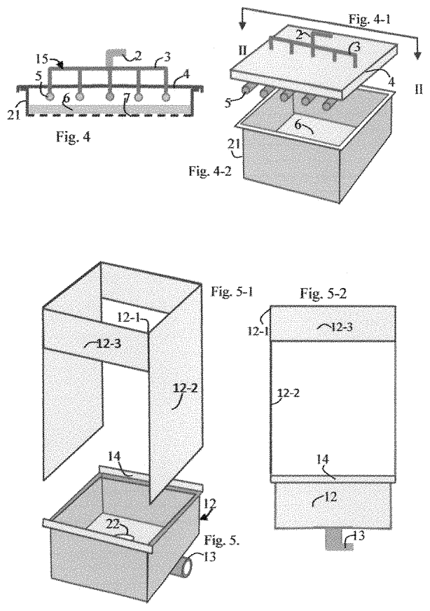

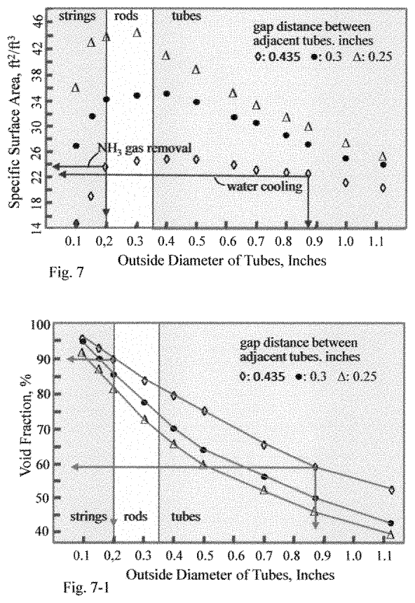

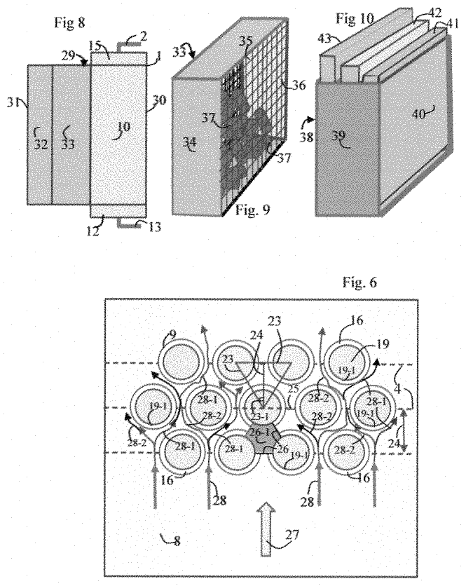

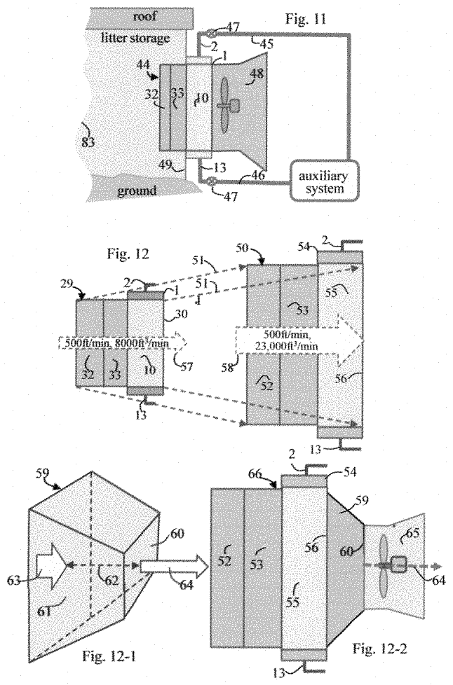

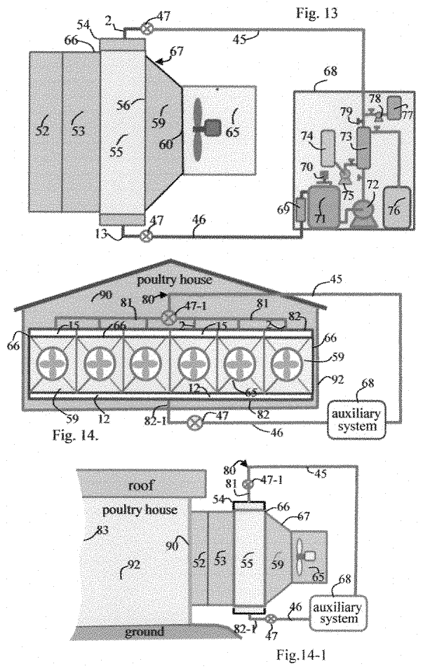

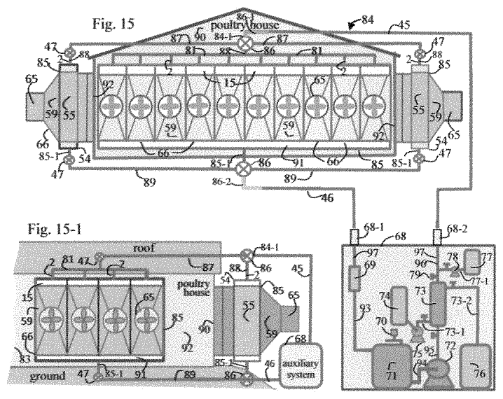

MRS bottom frame 16-1: Metal-Rod-filled-tube-Screen (MRS) attached bottom frame made up by attaching MRS on the bottom frame to be in one single structure as shown in FIG. 5-1

MRS bottom frame cavity 17-1: partial PTSF cavity without top frame cavity comprising cavity surrounding the MRS and bottom frame cavity shown in FIG. 1-1.

MRSF 29: Metal-Rod-Filled-Tube-Screen-Fill comprising top and bottom frames and metal-rod-tube-screen between them.

Metal-rod-filled-tube 23: tube is filled with metal rod.

Plastic-tube-screen-fill (PTSF) 29: a plurality of tubes are vertically installed in the shape of a flat-plate rectangular string screen between the top and bottom ring-shaped holes perforated frames by attaching their both ends on the inner circles of the ring-shaped holes provided on the inner surfaces along the axes of the frames at a tube-regular-spacing between the adjacent tubes on the frames, referred to U.S. Pat. No. 10,046,502 B2.

Poultry AHD: poultry ammonia gas, hydrogen sulfide gas, and dust-particles produced from poultry production activities.

PTSF cavity 28-1: PTSF-shape space formed surrounding the MRSF within the cavity partial-mold.

SSA: abbreviation of Specific Surface Area defining a ratio of surface area of total tubes in a unit volume of cubic feet, ft²/ft³.

Tube cavity 25: tube-shape space formed surrounding the metal-rod-filled-tube surface by covering the upper and lower metal-rod-filled-tube halves with hollowed-out tube cavity halves on the inner surfaces of the upper and lower partial-molds.

### DETAILED DESCRIPTION OF THE PREFERED EMBODIMENT

The poultry production facilities include naturally ventilating open-litter-storage and poultry house ventilated by ventilation fans. To collect and remove the poultry AHD released from the stacked litter in the open-litter-storage, the open-litter-storage needs adjusting of the open storage into an enclosed storage like the poultry house. As the poultry house uses large and standard ventilation fans for ventilation of poultry AHD in the poultry house and the litter storage uses natural ventilation for removal of the poultry AHD produced from the stacked litter, their installations of the poultry AHD removal systems are different. The poultry AHD removal equipment shown in FIG. 8 is called “standard NH₃ gas removal equipment.” The standard poultry AHD removal equipment is installed at the litter storage, after adjusting of the open litter storage into an enclosed storage, without any modifying of the standard poultry AHD removal equipment. However, the standard poultry AHD removal equipment must be modified in order to be installed at the poultry house, which is described in the following section as well as an installation of the standard poultry AHD removal equipment at the litter storage.

<Installation of Standard Poultry AHD Removal Equipment at Litter Storage> In order to collect and remove the poultry AHD emitted from the current stacked litter in the open-litter-storages, the open-litter-storages are needed to be adjusted into enclosed storages like the poultry house and then the standard poultry AHD removal equipment shown in FIG. 8 is installed on the wall of the enclosed litter storage. In the enclosed litter storage, the standard poultry AHD removal equipment with a medium size ventilation fan and an auxiliary system attached is installed on the wall of the newly enclosed storage facility as shown in FIG. 11. The standard poultry AHD removal equipment with medium size ventilation fan and an auxiliary system attached shown in FIG. 11 is called the standard poultry AHD removal system. The ventilation fans to be used in the enclosed litter storages have maximum blowing rates of 5500 ft³/min (cfm) (fan size, 30″ blades) and air blowing speed of 500 ft/min which is allowed in the tube-screen-scrubber pack. When the standard poultry AHD removal system is installed in the enclosed litter storage, the devices of dust filter and H₂S absorber in the standard poultry AHD removal equipment are placed on the inside wall of the enclosed storage and the tube-screen-scrubber device combined with ventilation fan placed on the outside wall of the enclosed litter storage as shown in FIG. 11. The tube-screen-scrubber pack equipped in the standard poultry AHD removal equipment is connected with the auxiliary system by connecting the working solution inlet and outlet ports of the standard poultry AHD removal equipment and the outlet and inlet working solution circulation pipes of the auxiliary system, respectively. The auxiliary system is located outside of the enclosed litter storage as shown in FIG. 11.

<Installation of Trapezoidal-Duct Assisting Expanded Poultry AHD Removal System at Poultry Houses> Since current commercial poultry houses are in various sizes up to a huge house of 10(H)×66(W)×600(L) ft³, two poultry houses of small 10(H)×40(W)×400(L) ft³ and huge 10(H)×66(W)×600(L) ft³ are selected to show how the trapezoidal-duct assisting expanded poultry AHD removal systems at the small and huge poultry houses, because their installations are different. The selected poultry houses need six and eighteen ventilation fans whose air flowing rates and fan blade sizes are same as 23,000 cfm and 54″, respectively. For the poultry house of 10(H)×40(W)×400(L) ft³, six trapezoidal-duct assisting expanded poultry AHD removal equipments are installed on the end side wall of the poultry house as shown in FIG. 14. The dimension of the single unit trapezoidal-duct assisting expanded poultry AHD removal equipment is 7(H)×6.6(W)×6.6(D) ft³, and then the total dimension of six equipments combined side by side as shown in FIG. 14 is in 7(H)×39.6(W)×6.6(D) ft³, which fully covers the cross section 10(H)×40(W) ft² of the end side wall of the poultry house as shown in FIG. 14. The side view of their installation on the end side wall of the poultry house is shown in FIG. 14-1. If the eighteen trapezoidal-duct assisting expanded poultry AHD removal equipments are installed in two layers on the end side wall of the huge poultry house 10(H)×66(W)×600(L), the height of two layered trapezoidal-duct assisting poultry NH₃ gas removal equipment becomes 14 ft, which is close to the top height, 16 ft, of poultry house. Hence, two layer of them cannot be installed on the end side wall of the poultry house. Therefore, they are installed in three groups such as ten units of the trapezoidal-duct assisting expanded poultry AHD removal equipments are installed in one layer on the end-side wall and four units of them each are installed on both side walls near to the end side wall of the poultry house as shown in FIGS. 15 and 15-1, respectively. Most important factor to be considered in case of installation of the ventilation fans divided in three groups is to keep an uniform flow of air flowing through the entire floor of the poultry house. To do so, as many as possible of the trapezoidal-duct assisting expanded poultry AHD removal equipments are installed on the end side wall and then half of rest of them each are installed on both side walls near to the end side wall of the poultry house. If the end side wall of the poultry house is enough to be higher than a double height of the trapezoidal-duct assisting expanded poultry AHD removal equipment and all of the equipments can be installed on the end side wall, such an installation condition of all equipments in one place is best chosen to allow air to uniformly flow in the poultry house.

<Operation of the Trapezoidal-Duct Assisting Expanded Poultry AHD Removal System Installed at Huge Poultry House> The trapezoidal-duct assisting expanded poultry AHD removal system 84 installed at the huge poultry house of 10(H)×66(W)×600(L) ft³ is schematically illustrated as shown in FIG. 15. The trapezoidal-duct assisting expanded poultry AHD removal system 84 consists a major system 84-1 comprising three subsystem 85 and an auxiliary system 68. The major system and auxiliary system are connected by connecting the major system inlet port 86-1 and outlet port 86-2 to respective working solution outlet and inlet ports of the auxiliary system. Such connections are accomplished by connecting the working solution supplying inlet circulation pipe 45 between major system inlet port 86-land auxiliary system outlet port 68-2 and the working solution returning outlet circulation pipe 46 between major system outlet port 86-2 and auxiliary system inlet port 68-1, respectively. The trapezoidal-duct assisting poultry AHD removal system 84 is assembled by combining side by side of eighteen units of the trapezoidal-duct assisting expanded poultry AHD removal equipments 66, which are grouped into three subsystems 85 installed apart on the end-side-wall 90 and both side-walls 92 of the poultry house as shown in FIGS. 15 and 15-1. The three subsystems 85 are connected each other by working solution subsystem supply pipes 87 which distribute the working solution supplied through the working solution supply circulation pipe 45 into three working solution subsystem supply pipes 87 after passing the four-way-controlling-valve 86. The four-way-controlling-valve is connected with the two working solution subsystem supply pipes 87, one working solution subsystem supply port 88, and the working solution supplying inlet circulation pipe 45. The working solution distribution pipes 81 distribute the working solution supplied through the working solution subsystem supply pipes 87 into the working solution supply boxes 15 on the top of the expanded tube-screen-scrubber packs 55 equipped in the trapezoidal-duct assisting expanded poultry AHD removal equipments 66 through working solution inlet ports 2 connected with the working solution distribution pipes 81. The working solution stored in the working solution supply boxes 15 uniformly passes the working solution uniform distributor 6 on the bottom 7 of the working solution supply (distribution) box 15 and then uniformly passes the top perforated plates 8 of the expanded tube-screen-scrubber packs 55 equipped in the trapezoidal-duct assisting expanded poultry AHD removal equipments 66. The working solution passed the top ring-shape hole perforated plates 8 uniformly flows down on the surfaces of the tubes 9 vertically suspended in the expanded tube-screen-scrubber packs 55. The NH₄⁺ dissolved working solution passed the expanded tube-screen-scrubber devices 54 is collected in the subsystem working solution collection sumps 91 provided at the bottom of the subsystems 85 shown in FIGS. 15 and 15-1 after passing through the water collection basins 12 of the expanded tube-screen-scrubber devices 54 in the equipments 66 of the subsystems 85. The NH₄⁺ dissolved working solution collected in the subsystem collection sumps 91 of three subsystems 85 flows out of the subsystems 85 through the three subsystem outlet ports 85-1 connected to the bottom of the three subsystems 85. The three lines of the NH₄⁺ dissolved working solutions, passing two discharging pipe lines of connecting a subsystem outlet port 85-1, two way valve 47, and working solution subsystem outlet pipe 89 and directly passing one subsystem outlet port 85-1, flow together into the working solution returning outlet circulation pipe 46 after passing four-way-controlling valve 86 which connects with the two working solution subsystem outlet pipes 89, directly connected with one subsystem outlet port 85-1, and working solution returning outlet circulation pipe 46 as shown in FIG. 15. The NH₄⁺ dissolved working solution having passed three subsystems 85 reaches to the auxiliary system 68 after passing through the working solution returning outlet pipe 46 and then enters the auxiliary system 68 through the working solution inlet port 68-1 attached on the auxiliary system 68. The NH₄⁺ dissolved working solution entered the auxiliary system 68 through the working solution inlet port 68-1 connected with a auxiliary circulation pipe 97 in the auxiliary system 68 is stored in the reservoir tank 71 after passing a wet-fine-dust-filter cartridge 69 on between the auxiliary circulation pipe-one 93 and the auxiliary circulation pipe 97. The auxiliary circulation pipe 97 in the auxiliary system 68 is connected with the working solution returning outlet circulation pipe 46 and supplying inlet circulation pipe 45 by connecting to respective working solution inlet 68-1 and outlet 68-2 ports of the auxiliary system 68. The auxiliary circulation pipe 97 consists primary components of a wet-fine-dust-filter cartridge 69, working solution reservoir tank 71, working solution circulation pump 72, and ion exchanger column 73 which are consecutively connected each other along with the auxiliary circulation pipe 97 made of by connecting of four portions of the auxiliary circulation pipe-one 93, -two 94, -three 95, and -four 96 as arranged along the auxiliary circulation pipe 97 as shown in the auxiliary system 68 shown in FIG. 15. By operation of the working solution circulation pump 72 in the auxiliary system 68, the NH₄⁺ dissolved working solution in the reservoir tank 71 is pumped out through the auxiliary circulation pipe-two 94 connected between the working solution circulation pump 72 and working solution reservoir tank 71 and passes through the auxiliary circulation pipe 79 sequentially assembled with the auxiliary circulation pipe-three 95, ion exchanger column 73, and auxiliary circulation pipe-four 96 within the auxiliary system 68 and then circulated into the major system 84-1 of the trapezoidal-duct assisting expanded poultry AHD removal system 84 through the major system inlet port 86-1 after passing through the working solution supply inlet circulation pipe 45 connected to the working solution outlet port 68-2 on the auxiliary system 68. While the NH₄⁺ dissolved working solution passes the ion exchanger column 74 within the auxiliary system 68, the NH₄⁺ ions dissolved in the NH₄⁺ dissolved working solution are removed from the NH₄⁺ dissolved working solution by trapping NH₄⁺ ions in the ion exchanger resin particles in the ion exchanger column 74 and the NH₄⁺ dissolved working solution becomes clean working solution, which is described in the section of <Regeneration of Ion Exchanger>. The cleaned working solution is supplied to the three subsystems 85 comprised in the major system 84-1 of the trapezoidal-duct assisting expanded poultry AHD removal system 84 through the working-solution-supply-inlet-circulation-pipe 45 after passing the ion exchanger column 74 in the auxiliary system 68. Likewise, the working solution is circulated through the three subsystems 85 connected each other in the major system 84-1 by operating the working-solution-circulation-pump 74.

<Functions of Auxiliary System> The auxiliary system 68 has a main function of circulating the working solution through the expanded poultry NH₃ gas removal tube-screen-scrubber device 54 equipped in the trapezoidal-duct assisting expanded poultry AHD removal system 84 using the working-solution-major-system-circulation-pipes 45, 46 connecting the major system 84-1 of the trapezoidal-duct assisting expanded poultry AHD removal system and the auxiliary system and the working solution circulation pump 75 in the auxiliary system 68. The auxiliary system 68 includes primary and secondary components. The primary components are a wet-fine-dust filter 69, working-solution-reservoir-tank 71, working-solution-circulation-pump 72, and ion-exchanger-column 73, which are sequentially connected along with the working-solution-auxiliary-circulation-pipe 97 and secondary components of HCl-solution-tank 77, HCl-solution-supply-pump 78, phosphoric-acid-solution-tank 74, phosphoric-acid-solution-supply-pump 75, ion-exchanger-regenerated-MAP-salt-solution reservoir tank 76, and automatic-tap-water-supplier 70 are directly or indirectly connected to the working-solution-circulation-pipe 45, 46 running throughout the auxiliary system 68 as shown in FIG. 15. The primary components are directly utilized to operate the three subsystems 85. While the trapezoidal-duct assisting expanded poultry AHD removal system 84 is operating, the working solution flows through the primary components in the auxiliary system 68 by following their sequential order described above and then passes through all of the expanded tube-screen-scrubber packs 55 in three subsystems 85 at the same time. During passing of the working solution through the expanded tube-screen-scrubber packs 55, the removal processes of NH₃ gas in the NH₃ gas contaminated air stream are carrying out in all of the expanded tube-screen-scrubber packs 55 for the NH₃ gas in the NH₃ gas contaminated air stream to transfer into the working solution and at the same time, the water in the working solution is evaporated to reduce the amount of water in the working solution. When the amount of water is reduced lower than required limit in the working solution, the loss of water is compensated through an automatic operation of the automatic controlling tap-water-valve 70 in the auxiliary system 68. The automatic supplying of the evaporated amount of water is essential to keep the perfect AHD removal capability of the trapezoidal-duct assisting poultry AHD removal system 84 for eliminating of the poultry AHD in the exhausted air stream discharging from the poultry facilities. Other function of the auxiliary system 68 is to convert the ammonium NH₄⁺ collected in the ion exchanger column 73 to MonoAmmonium Phosphate (MAP, NH₄(H₂PO₄) fertilizer, which is described in the section of <Production of MonoAmmonium Phosphate Fertilizer>.

<Cross-Current Contacting of NH₃ Gas Contaminated Air and Working Solution Streams in Tube-Screen-Scrubber Device> After passing the dust filter 52 and H₂S gas adsorber 53 devices equipped in the expanded poultry AHD removal equipments 66, the poultry AHD contaminated air streams contain the NH₃ gas and a small amount of remaining fine dust particles unable to be filtered in the dust filter device and then horizontally enter the expanded NH₃ gas removal tube-screen-scrubber devices 54 in which the working solution has been flowing down over the surfaces of the vertical long-tubes 9 vertically installed in the device 54. The NH₃ gas and fine dust particle contaminated air streams pass transversely through the vertical long-tubes 9 vertically installed in the tube-screen-scrubber devices 54 to cross-currently contact with the film-shape working solutions containing H⁺ and Cl⁻ ions flowing down over the surfaces of the vertical long-tubes 9. During cross-currently contacting each other of the NH₃ gas and fine dust particle contaminated air stream and working solution stream on the surfaces of the film-shape working solution flowing down over the vertical long-tubes 9, the NH₃ gas and remaining fine-dust-particles in the air stream are respectively dissolved and transferred into the working solution. The NH₃ gas dissolved in the working solution is reformed into the liquid phase ammonia gas, NH₃(aq), in the working solution. The liquid phase NH₃(aq) is immediately and completely trapped by being converted to liquid phase, NH₄⁺(aq), due to chemical reaction with acid, H⁺, in the working solution. Such a cross-current contact of the contaminated air stream passing transversely through the vertical long-tubes 9 and the working solution stream vertically flowing down over the surface of the vertical long-tubes 9 continuously occurs on the surfaces of all long-tubes 9 arranged in the zigzag configuration within the device 54 until both of the air and working solution streams completely pass out of the tube-screen-scrubber device 54. Hence, the NH₃ gas and fine dust-particles in the air stream are completely removed into the working solution stream, which means that the clean air is discharged into the environment surrounding the poultry houses and that the working solution passed through the tube-screen-scrubber devices 54 containing the base ions of H⁺ and Cl⁻ and liquid phase NH₄⁺ ions and small amount of fine dust-particles is circuited into the three. subsystems 85 of the major system 84-1 after passing through the auxiliary components of the wet-fine-dust-filter-cartridge 69, working solution reservoir tank 71, working solution circulation pump 75, and ion exchanger column 73, which are consecutively connected on along the working solution pipe 45 in the auxiliary system 68 as shown in FIG. 15. While the working solution is passing through the auxiliary system 68, the dust particles are filtered in the the wet-fine-dust-filter cartridge 69 and the NH₄⁺ ions are removed from the working solution by exchanging with ion-exchanger-resin-phase H⁺ ions on the ion exchanger resin beads in the ion exchanger column 73. Therefore, the working solution supplying to the three subsystems 85 contains only the base ions of H⁺ and Cl⁻ such as in the initial chemical state of the working solution. Likewise, the trapezoidal-duct assisting poultry AHD removal system 84 operates while the chemical state of the ion exchanger column, the NH₄⁺ ions trapped in the acid working solution are completely scrubbed into the ion exchanger resin beads, continues until a non-zero or allowable limit breakthrough concentration of the NH₄⁺ ions in the spent acid working solution discharged from the ion exchanger column 73 is detected. The non-zero breakthrough concentration of NH₄⁺ ions detected in the spent acid working solution notifies previously a rapid increasing of the NH₄⁺ ion concentration in the working solution or closing to the allowable limit breakthrough concentration due to rapid dropping off of the NH₄⁺ ion adsorption capability of the ion exchanger resin in the column 73, which rapid dropping-off of the NH₄⁺ adsorption capability of the ion exchanger resin indicates that the H⁺ form ion exchanger resin is almost fully changed into the NH₄⁺ form resin. Hence, when the non-zero or close allowable limit breakthrough concentration of the NH₄⁺(aq) ions detected in the spent acid working solution, the operation of the trapezoidal-duct assisting poultry AHD removal system is stopped and then the ion exchanger column is to be regenerated, which is described in the section of <regeneration of ion exchanger column>.

<Variation of Chemical Components in Working Solution While Working Solution Circulates through Circulation Pipe> The working solution is the hydrochloride acid water which is made of by adding HCl solution in water. So, the fresh working solution in the working solution reservoir tank 71 at the initial time contains hydrogen cation H⁺ and chloride anion Cl⁻ in water with no any other chemical components. The fresh working solution circulating through the main system 84 contacts for the first time with the NH₃ gas and small amount of fine dust-particles remained in the exhausted air stream on the surfaces of the tubes 9 vertically suspended in the NH₃ gas removal tube-screen-scrubber device 54 equipped in the trapezoidal-duct assisting expanded poultry AHD removal equipment 66. The NH₃ gas present in the air stream dissolves into the working solution stream by penetrating through the interfaces between the NH₃ gas contaminated air and working solution streams. When the NH₃ gas dissolves in the working solution, the chemical components present in the working solution are H₂O, NH₄⁺(aq), and CL⁻ as follows.

H₂O+H⁺+Cl⁻+NH₃(g) ↔ H₂O+H⁺+Cl⁻+NH₃(aq) ↔ H₂O+NH₄⁺(aq)+Cl⁻ (4)

The small amount of fine dust-particles remained in the air stream is quickly transferred to the working solution as the dust-particles are easily absorbed into the water. Therefore, the working solution passed through the NH₃ gas removal tube-screen-scrubber devices 54 contains NH₄⁺, Cl⁻, and fine dust-particles, which continuously flows through the working solution outlet circulation pipes 89 and working solution return inlet circulation pipe 46 to reach the circulation solution reservoir tank 71 after filtering the fine dust-particles through the wet-fine-dust-filter cartridge 69 on the circulation pipe 46 as shown in FIG. 15. The working solution reached and stored in the working solution reservoir tank 71 contains NH₄⁺, H⁺, and Cl⁻. The working solution stored in the reservoir tank 71 is pumped out for next cycles of circulation through the working solution circulation pipe 45 after passing through the ion exchanger column 73. While the working solution passes the ion exchanger column 73, the liquid phase NH₄⁺ gets into the ion-exchanger resin beads through micro-pores on the ion exchanger beads and replaces H⁺ on the ion-exchanger beads owing to the stronger chemical affinity of the NH₄⁺ according to the chemical reaction as follows.

NH₄⁺+Cl⁻+R—H⁺→H⁺+Cl⁻+R—NH₄⁺ (5)

where R—H is the H⁺ form ion exchanger resin and R—NH₄⁺ is the NH₄⁺ form ion exchanger resin. The NH₄⁺ chemical bonded on the ion exchanger bead is not replaced by H⁺ itself because of weaker chemical affinity of the H⁺ ion than that of the NH₄⁺ ion, so that the chemical reaction between the NH₄⁺ and R—H⁺ occurs in one direction as shown in Eq. (5) until their equilibrium state is reached. Hence, the working solution passed the ion exchanger column 73 contains hydrogen cation H⁺ and chloride anion Cl⁻. Consequently, the working solution after passing the ion exchanger column 73 contains H⁺ and Cl⁻ as in the initial chemical state of the working solution and the H⁺ is used again to capture the NH₃ gas from the exhausted air stream. Likewise, the amount of hydrochloride in the working solution does not change and the NH₃ gas absorbed from the exhausted air stream emitted from the poultry facilities is stored in the ion exchanger after converting the NH₃(aq) to NH₄⁺ ion by capturing the NH₃(aq) with H⁺ in the working solution.

<Regeneration of Ion Exchanger Column> While operating of the main system of the trapezoidal-duct assisting expanded poultry AHD removal system 84, when an allowable threshold concentration limit (e.g. reaching to an equilibrium state between the liquid phase NH₄⁺ ions in the working solution and resin phase NH₄⁺ in the ion exchanger resins) is passed or an adsorption capability of the ion exchanger resin for liquid phase NH₄⁺ions in the working solution is significantly dropped off, the operation of the main system is stopped and the ion exchanger resin column is necessary to be regenerated. Namely, the chemical state of significantly dropping off of adsorption capability of the ion exchanger resin for the liquid phase NH₄⁺ ions indicates close to an equilibrium state between the liquid phase and resin phase NH₄+ ions as shown in Eq. (6) given below. The chemical components present in the working solution and ion exchanger resin in the ion exchanger column are small amount of NH₄⁺(aq) and R—H⁺ and large amount of HCL and R—NH₄⁺, which are in equilibrium state as shown in Eq. (6).

NH₄⁺+Cl⁻+R—H⁺ ↔ H⁺+Cl⁻+R—NH₄⁺ (6)

where R—NH₄⁺ and NH₄⁺ are in resin and liquid phases, respectively. If the adsorption capability of the liquid phase NH₄⁺ ions of the ion exchanger resin is in an enough room, the HCl solution is added to the working solution from the HCl solution tank by operating the working solution supply pump as shown in the auxiliary system shown in FIG. 15 and then the main system of the trapezoidal-duct assisting expanded poultry AHD removal system is continuously operated. If not, the ion exchanger column is regenerated. To regenerate the ion exchanger resin formed with high-affinity NH₄⁺ ions than H⁺ ions, the high concentrate H⁺ solution is necessary to be applied to regenerate the NH₄⁺ form ion exchanger resin. Hence, to provide the high concentration of H⁺ ions in the regenerating solution, a high concentrated H₃PO₄ acid solution is chosen because the H₃PO₄ provides H⁺ ions to increase the liquid phase H⁺ ions and simultaneously produces a fertilizer by reacting with the NH₄⁺ ions exchanged with the concentrate H⁺ ions. The high concentrated regeneration H₃PO₄ acid solution is supplied into the ion exchanger column through the bottom inlet port of the ion exchanger column by operating of the regeneration phosphoric acid solution pump from the regeneration phosphoric acid tank and the spent regeneration phosphoric acid solution is discharged out through the outlet port on top of the ion exchanger column and collected in the MonoAmmonium Phosphate (MAP) salt collection tank. While passing of the regeneration phosphoric acid solution upwards through the ion exchanger column, the resin phase NH₄⁺ ions on the ion exchanger resin are exchanged with the concentrated acid H⁺ions in the regeneration solution to become liquid phase, NH₄⁺(aq), in the regeneration phosphoric acid solution and then the NH₄⁺(aq) chemically reacts with phosphoric acid, H₂PO₄⁻, in the working solution to produce the MAP, NH₄(H₂PO₄), salt in the regeneration H₃PO₄ acid solution as shown in Eq (7). The Eq. (7) shows

R—NH₄+HCl+H⁺+H₂PO₄⁻→R—H+NH₄⁺(aq)+HCl+H₂PO₄⁻→R—H+HCL+NH₄(H₂PO₄) ↓ (7)

three steps of chemical reactions between the regeneration H₃PO₄ acid solution and NH₄⁺ form ion exchanger resin to produce the MAP salt fertilizer and to change the NH₄⁺ form ion exchanger resin into H⁺ form. These chemical processes occur while passing of the regeneration H₃PO₄ acid solution through the ion exchanger column. The spent regeneration H₃PO₄ acid solution passed out of the ion exchanger column contains HCl solution and MAP salt, which is collected in the MAP salt collection tank. Since the NH₄⁺ form ion exchanger resin is regenerated by once-through-passing of the regeneration solution through the ion exchanger column, the NH₄⁺ form ion exchanger resin is contacted with fresh regeneration solution all through the processing of the ion exchanger regeneration. Hence, the NH₄⁺ form ion exchanger resin in the ion exchanger column is completely regenerated to be in the H⁺ form ion exchanger resin, which is ready for next operation of the standard and trapezoidal-duct assisting expanded poultry AHD removal systems.

<Production of MonoAmmonium Phosphate Fertilizer> To regenerate the NH₄⁺ formed ion exchanger resin contained in the ion exchanger column 73, firstly, on/off valves 79 on the working solution circulation pipes connected to the bottom and top portion of the ion exchanger column are closed and the on/off valves on regeneration H₃PO₄ acid solution supplying pipe 73-1 attached to the bottom portion of the ion exchanger column and spent regeneration solution discharging pipe 73-2 respectively connected to the bottom and top portions of the ion exchanger column 73 are open. Then, the regeneration H₃PO₄ acid solution is supplied into the ion exchanger column73 through the regeneration supply pipe 73-1 from the H₃PO₄ acid solution tank 74 by operating of the regeneration solution supply pump 75 as shown in the auxiliary system 68 shown in FIG. 15. While the H₃PO₄ acid solution containing concentrated H⁺, Cl⁻, and H₂PO₄⁻ is passing upwards through the ion exchanger column 73, the concentrated acid H⁺ ions in the regeneration solution replace the resin phase NH₄⁺ ions on the ion exchanger resin, R—NH₄, to become liquid phase NH₄⁺(aq) in the regeneration solution and then the NH₄⁺(aq) reacts with phosphoric acid, H₂PO₄⁻, in the regeneration solution to produce MonoAmmonium Phosphate (MAP, NH₄(H₂PO₄)) salt in the regeneration solution as shown in Eq (7). Such chemical processes of exchanging of resin phase NH₄⁺ ions with acid H⁺ ions and producing of MAP by reacting of NH₄⁺(aq) with H₂PO₄⁻ in the regeneration solution start at the bottom of the column 73 and continue all through the column 73 until the spent regeneration solution discharges out of the ion exchanger column 73 through the spent regeneration solution discharging pipe 73-2 attached top portion of the column 73. The regeneration process of the ion exchanger column 73 is continued until the NH₄⁺(aq) ions are not detected or lower than a required concentration of the NH₄⁺ ions in the spent regeneration solution. During the regenerating process of the NH₄⁺ formed ion exchanger resin column, the spent regeneration solution generated in the column 73 is discharged through the spent regeneration solution discharging pipe 73-2 attached top portion of the column 73 and stored in the MAP salt solution collection tank 76. The MAP is weak soluble in the water so that the MAP salt solution is dried to produce solid MAP fertilizer particles. Using molar masses of MAP (NH₄H₂PO₄) and phosphoric acid are 149 and 98 g/mol, respectively, it is understood that to produce 149 g of MAP fertilizer, 51 g/mol of ammonia is necessary. Therefore, daily ammonia emission rate from 110,000 broiler chicken house was 66 lb NH₃/day-house by using 0.27 g NH₃/day/bird at previous assumption (Now, 0.54 g NH₃/day/bird) due to Environmental Integrity Project reported on Jan. 22, 2018 for poultry broiler house producing 110,000 [4]. In case of 90% removed ammonia, the Amount of MAP fertilizer produced was 90 lb/day-house (66 lb/d×0.9×149.09/98 equal to 90 lb/day). But now it may be 180 lb/day for the chicken house producing 110,000 broilers, based on assumption of 2 times increased broiler production compared to the old data.

The tube-screen-scrubber device of the present invention is invented for removing of the poultry ammonia gas from the exhausted air stream emitting from the poultry production facilities, supplementing the disadvantages of the current wet-scrubber devices. The tube-screen-scrubber pack being employed in the tube-screen-scrubber device satisfactorily meets the well-known three grouped requirements of packing materials necessary to effectively perform scrubbing of gas described in the section of <Disadvantages of Current Commercializing Cross-Current-Type Packed Bed>. The structured packing material of the tube-screen-scrubber pack is same with that of the tube-screen-fill pack patented by the present inventor for improving the drawbacks of the current cooling tower fill pack. The tube-screen-scrubber pack has been verified by operating of the prototype cooling tower for the performance-testing of the tube-screen-fill pack and current cooling tower PVC film fill pack, having obtained a 30% higher water cooling efficiency compared to that of the current cooling tower PVC film fill pack and a specific surface area of 24 ft²/ft³ compared to 55 ft²/ft³ for cooling tower PVC film fill pack. Applying such approved tube-screen-scrubber packs in the poultry NH₃ gas removal tube-screen-scrubber device invented in the present invention, it is believed that the trapezoidal-duct assisting poultry AHD removal system uniquely applied and invented in the present invention removes all sources emitting from the poultry farms providing major causes to the environmental problems and to the opposition of the residential communities surrounding the poultry farms against the expansion of the existing poultry farms.

While only specific embodiments of the invention has been described and shown, this invention may be further modified and altered within the concept and scope of this disclosure. This application is therefore intended to cover any modifications, alterations, variations, adaptations, or use of the invention using its general principles. Further, it is intended to include all such modifications and alterations insofar as they come within the scope of the appended claims or the equivalent thereof.

What is claimed is:

1. A trapezoidal-duct assisting poultry ammonia gas, hydrogen sulfide gas, and dust removal system for removing of poultry ammonia gas, hydrogen sulfide gas, and dust-particles from an exhausted air stream emitting from poultry production houses and litter storages comprises;
(a) a tube-screen-scrubber device for removing of the ammonia gas from an exhausted air stream by contacting of the exhausted air and working solution streams on the surfaces of tubes equipped in the tube-screen-scrubber device;
(b) a hydrogen sulfide gas adsorber device for removing of the hydrogen sulfide gas from the exhausted air stream by adsorbing the hydrogen sulfide gas on the surfaces of hydrogen sulfide adsorbent pellets loaded in the device;
(c) a dust filter device for removal of the dust particles to protect local residential healths and for safe operations of the hydrogen sulfide adsorber and ammonia gas removal tube-screen-scrubber devices;
(d) a trapezoidal-duct adjusting to deliver a high flow rate in high speed of air stream passing the ventilation fan to a low speed of air passing a large cross section of the tube-screen-scrubber device to deliver a same flow rate of air;
(e) a ventilation fan blowing air contaminated with poultry ammonia gas, hydrogen sulfide gas, and dust out of the poultry houses and litter storages;
(f) an auxiliary system controlling to circulate working solution through the expanded poultry ammonia gas removal tube-screen-scrubber device equipped in the poultry ammonia gas, hydrogen sulfide gas, and dust removal system.

2. The tube-screen-scrubber device comprising a tube-screen-scrubber pack, working solution supply box, and working solution collection sump, wherein the working solution supply box and the working solution collection sump are attached on the top and bottom of tube-screen-scrubber pack, and wherein the working solution supply box consists the working solution supply box cover with working solution supplying port on top and the bottom mesh net with working solution uniform distributer placed on the mesh net, and wherein the working solution collection sump consists a square box with open top and upper rim of the sump able to be fit with the bottom square plate of the tube-screen-scrubber pack and a working solution outlet port on the bottom plate of the sump.

3. The tube-screen-scrubber pack comprising top and bottom ring-shaped hole perforated plates and a plurality of tubes vertically suspended between the top and bottom ring-shaped hole perforated plates and fixed through the ring-shaped holes on the ring-shaped hole perforated plates, wherein the ring-shaped holes on the top and bottom perforated plates and the tubes suspended in the tube-screen-scrubber pack are lined up transversely to the air flowing direction and the ring holes and tubes are arranged in zigzag shapes along the air flowing direction, and wherein the tube-screen-scrubber pack is assembled side by side of a plenty of tube-screen-scrubbers.

4. The tube-screen-scrubber comprising top and bottom ring-shaped hole perforated frames and multiple tubes suspended between the top and bottom ring-shaped hole perforated frames, wherein the ring-shaped holes on the ring-shaped hole perforated frame are formed by surrounding the end plugged portion of the tubes positioned at the center of the ring-shaped holes and lined up along the longitudinal axis of frame are placed at a tube regular spacing between the adjacent tubes along the ring-shaped hole perforated frame, and wherein the tube near the one edge of the tube-screen-scrubber frame is apart from the edge of the frame by a quarter length of the tube regular spacing, while the one near the other side edge apart by three quarter length of the tube regular spacing, and the other tubes in the middle frame are apart from each other by the tube regular spacing.

5. A trapezoidal-duct assisting poultry ammonia gas, hydrogen sulfide gas, and dust removal system of claim 1, wherein the trapezoidal-duct is in a shape of a square duct reducer consisting an air inlet large square open cross section and an air outlet small square open cross section, wherein the air inlet large square open cross section and the outlet small square open cross section of the trapezoidal-duct are same with the air outlet cross section of the tube-screen-scrubber device and the air inlet cross section of a ventilation fan, respectively, and wherein the height of the trapezoidal-duct is as long as possible.
